(19) United States
(12) Patent Application Publication
(10) Pub. No.: US 2020/0030066 A1
(43) Pub. Date: Jan. 30, 2020

(54) DENTAL CLEANING TOOL INCLUDING AT LEAST ONE MOVEABLE SECONDARY TOOL

(71) Applicant: WORLD WIDE DAILY HOLDINGS COMPANY LIMITED, Hong Kong (CN)

(72) Inventor: Chun Yuen TO, Hong Kong (CN)

(73) Assignee: World Wide Daily Holdings Company Limited, Hong Kong (CN)

(21) Appl. No.: 15/558,866

(22) PCT Filed: Mar. 3, 2017
(86) PCT No.: PCT/CN2017/075574

§ 371 Date: Sep. 15, 2017

(51) Int. Cl. A61C 15/02; A61C 15/04; A46B 15/00

(52) U.S. Cl. CPC A61C 15/02; A46B 2200/108; A46B 15/0069; A61C 15/046

(57) ABSTRACT

A dental cleaning tool includes a handle defining a longitudinal axis of the tool. The handle includes a floss holder having a base and two arms extending from the base in perpendicular relation to the longitudinal axis, at least one strand of floss extending between the two arms, and a toothpick being formed as one piece with the handle and having a pointed tip, the toothpick being spaced from the floss holder such that the handle is disposed between the toothpick and the floss holder. The dental cleaning tool further includes at least one rotatable dental tool formed separately from and attached to the handle, the at least one rotatable dental tool being rotatably mounted to the handle between a first, stow position and a second, use position.

### FIELD

The field of this disclosure relates generally to dental cleaning tools, and more specifically, to a dental cleaning tool including at least one moveable, secondary dental cleaning tool.

### BACKGROUND

Dental cleaning tools are used to remove food remnants and/or build-up from the surface of or between teeth. As a result, some known dental cleaning tools include a brush for cleaning the surface of teeth and other known dental cleaning tools include floss and/or a pick for removing or loosening food remnants (or other debris) lodged between adjacent teeth. However, often known dental cleaning tools can be difficult for a user to manipulate because the dental cleaning tool has to be at least partially inserted inside the user's mouth. Moreover, the user has to hold the dental cleaning tool awkwardly to reach and clean teeth located in the back of the mouth. Thus, known dental cleaning tools are difficult to use on or between teeth located in or near the back of the mouth. In additional, the user often has to switch between discrete tools (e.g., a brush, floss, and/or a pick) to realize the various benefits of each of these tools.

Some conventional dental cleaning tools include combinations of floss, a pick, and/or a brush, which often exacerbates the difficulty of using the dental cleaning tool. For example, the user may have to hold and manipulate the dental cleaning tool in a manner that is uncomfortable to hold or have inserted into ones mouth. Additionally, the floss, pick, and/or brush may obstruct use of the other components of the dental cleaning tool. For example, the floss, pick, or brush may be attached such that the user has difficulty positioning other portions of the dental cleaning tool inside the user's mouth. As a result, some users may skip or ineffectively clean portions of their teeth to avoid discomfort.

Accordingly, there is a need for improved dental cleaning tools that combine a number of dental cleaning tools and are comfortable to use in an easy and effective manner.

### BRIEF DESCRIPTION

In one aspect, a dental cleaning tool generally comprises a handle defining a longitudinal axis of the tool. The handle generally comprises a floss holder having a base and two arms extending from the base in perpendicular relation to the longitudinal axis of the tool, at least one strand of floss extending between the two arms, and a toothpick being formed as one piece with the handle and having a pointed tip. The toothpick is spaced from the floss holder such that the handle is disposed between the toothpick and the floss holder. The dental cleaning tool further comprises at least one rotatable dental tool formed separately from and attached to the handle. The at least one rotatable dental tool is rotatably mounted to the handle between a first, stow position and a second, use position.

In another aspect, a dental cleaning tool generally comprises a handle defining a longitudinal axis of the tool. The handle generally comprises a floss holder having a base and two arms extending from the base in perpendicular relation to the longitudinal axis of the tool, at least one strand of floss extending between the two arms, and a toothpick being formed as one piece with the handle and having a pointed tip. The toothpick is spaced from the floss holder such that the handle is disposed between the toothpick and the floss holder. The dental cleaning tool further comprises at least one slideable dental tool formed separately from and attached to the handle. The at least one slideable dental tool is slidably mounted to the handle between a first, stow position and a second, use position.

In a further aspect, a dental cleaning tool generally comprises a handle defining a longitudinal axis of the tool. The handle generally comprises a floss holder having a base and two arms extending from the base in perpendicular relation to the longitudinal axis of the tool, at least one strand of floss extending between the two arms, and a toothpick being formed as one piece with the handle and having a pointed tip. The toothpick is spaced from the floss holder such that the handle is disposed between the toothpick and the floss holder. The dental cleaning tool further comprises at least one detachable dental tool formed separately from and attached to the handle. The at least one detachable dental tool is detachably mounted to the handle between a first, stow position and a second, use position.

### BRIEF DESCRIPTION OF THE DRAWINGS

FIGS. 1 and 2 are left and right side perspectives of one suitable embodiment of a dental cleaning tool including a rotatable toothpick tool and a rotatable brush tool, both the rotatable toothpick tool and the rotatable brush tool being in a first, stow position.

FIG. 3 is a left side elevation of the dental cleaning tool showing the rotatable brush tool in a first, stow position.

FIG. 4 is a right side elevation of the dental cleaning tool showing the rotatable toothpick tool in a first, stow position.

FIG. 5 is a bottom view of the dental cleaning tool.

FIG. 6 is a rear view of the dental cleaning tool.

FIG. 7 is a front view of the dental cleaning tool.

FIG. 8 is a left side perspective of the dental cleaning tool with the rotatable toothpick tool in a second, use position.

FIG. 9 is a right side perspective of the dental cleaning tool with the rotatable brush tool in a second, use position.

FIG. 10 is a right side perspective view of the dental cleaning tool with the rotatable toothpick tool in a first, use position, illustrating a first position nub and catch interface.

FIG. 10A is an enlarged, cross-section taken from FIG. 10 showing the interface between the first position nub and catch.

FIG. 11 is a right side perspective view of the dental cleaning tool with the rotatable toothpick tool in a second, stow position, illustrating the second position nub and catch interface.

FIG. 11A is an enlarged, cross-section taken from FIG. 11 showing the interface between the second position nub and catch.

FIG. 12 is a right side elevation view of the dental cleaning tool showing a center point and a longitudinal axis of the dental cleaning tool.

FIG. 13 is left side elevation view of the dental cleaning tool showing the rotatable toothpick tool in a second, use position and the rotatable brush tool in a first, stow position.

FIG. 14 is a bottom view of the dental cleaning tool showing the rotatable toothpick tool in a second, use position and the rotatable brush tool in a first, stow position.

FIG. 15 is a right side elevation view of the dental cleaning tool showing the rotatable toothpick tool in a first, stow position and the rotatable brush tool in a second, use position.

FIG. 16 is a bottom view of the dental cleaning tool showing the rotatable toothpick tool in a first, stow position and the rotatable brush tool in a second, use position.

FIG. 17 is a right side elevation of the dental cleaning tool showing a rotational angle of the rotatable toothpick tool.

FIG. 18 is a left side elevation of the dental cleaning tool showing a rotational angle of the rotatable brush tool.

FIG. 19 is an exploded perspective view of the dental cleaning tool showing the rotatable toothpick tool and the rotatable brush tool spaced from the dental cleaning tool.

FIG. 20 is a left side elevation view of the dental cleaning tool showing the rotatable toothpick tool and the rotatable brush tool removed therefrom.

FIG. 21 is a right side elevation view of the dental cleaning tool showing the rotatable toothpick tool and the rotatable brush tool removed therefrom.

FIG. 22 is a left side elevation view of the rotatable toothpick tool of the dental cleaning tool.

FIG. 23 is a top view of the rotatable toothpick tool of the dental cleaning tool.

FIG. 24 is a perspective view of the rotatable toothpick tool of the dental cleaning tool.

FIG. 25 is a right side elevation view of the rotatable toothpick tool of the dental cleaning tool.

FIG. 26 is a left side elevation view of the rotatable brush tool of the dental cleaning tool.

FIG. 27 is a top view of the rotatable brush tool of the dental cleaning tool.

FIG. 28 is a right side elevation view of the rotatable brush tool of the dental cleaning tool.

FIG. 29 is a perspective view of the rotatable brush tool of the dental cleaning tool.

FIG. 30 is a left side elevation view of a rotatable triple row brush tool suitable for use with the dental cleaning tool.

FIG. 31 is a top view of the rotatable triple row brush tool of the dental cleaning tool.

FIG. 32 is a right side elevation view of the rotatable triple row brush tool of the dental cleaning tool.

FIG. 33 is a left side perspective view of the rotatable triple row brush tool of the dental cleaning tool.

FIGS. 34 and 35 are left and right side perspectives of one suitable embodiment of a dental cleaning tool including a slideable toothpick tool and slideable brush tool, both the slideable toothpick tool and the slideable brush tool being in a first stow, position.

FIG. 36 is a left side elevation of the dental cleaning tool showing the slideable brush tool in a first, stow position.

FIG. 37 is a right side elevation of the dental cleaning tool showing the slideable toothpick tool in a first, stow position.

FIG. 38 is a bottom view of the dental cleaning tool.

FIG. 39 is a rear view of the dental cleaning tool.

FIG. 40 is a front view of the dental cleaning tool.

FIG. 41 is a left side perspective of the dental cleaning tool with the slideable toothpick tool in a second, use position.

FIG. 42 is a right side perspective of the dental cleaning tool with the slideable brush tool in a second, use position.

FIG. 43 is a right side elevation view of the dental cleaning tool with each of the slideable toothpick tool and the slideable brush tool in a first, stow position.

FIG. 44 is left side elevation view of the dental cleaning tool showing the slideable toothpick tool in a second, use position and the slideable brush tool in a first, stow position.

FIG. 45 is a right side elevation of the dental cleaning tool showing the slideable toothpick tool in a second, use position and the slideable brush tool in a first, stow position.

FIG. 46 is a top cross-sectional view of the dental cleaning tool with the slideable toothpick tool in a second, use position and the slideable brush tool in a first, stow position.

FIG. 47 is a bottom view of the dental cleaning tool showing the slideable toothpick tool in a second, use position and the slideable brush tool in a first, stow position.

FIG. 48 is a right side elevation view of the dental cleaning tool showing the slideable toothpick tool in a first, stow position and the slideable brush tool in a second, use position.

FIG. 49 is a left side elevation of the dental cleaning tool showing the slideable toothpick tool in a first, stow position and the slideable brush tool in a second, use position.

FIG. 50 is an exploded perspective view of the dental cleaning tool showing the slideable toothpick tool and the slideable brush tool spaced from the dental cleaning tool.

FIG. 51 is a left side elevation view of the dental cleaning tool showing the slideable toothpick tool and the slideable brush tool removed.

FIG. 52 is a right side elevation view of the dental cleaning tool showing the slideable toothpick tool and the slideable brush tool removed.

FIG. 53 is a left side elevation view of the slideable toothpick tool of the dental cleaning tool.

FIG. 54 is a top view of the slideable toothpick tool of the dental cleaning tool.

FIG. 55 is a right side elevation view of the slideable toothpick tool of the dental cleaning tool.

FIG. 56 is a perspective view of the slideable toothpick tool of the dental cleaning tool.

FIG. 57 is a left side elevation view of the slideable brush tool of the dental cleaning tool.

FIG. 58 is a top view of the slideable brush tool of the dental cleaning tool.

FIG. 59 is a right side elevation view of the slideable brush tool of the dental cleaning tool.

FIG. 60 is a perspective view of the slideable brush tool of the dental cleaning tool.

FIG. 61 is a left side elevation view of a slideable triple row brush tool suitable for use with the dental cleaning tool.

FIG. 62 is a top view of the slideable triple row brush tool of the dental cleaning tool.

FIG. 63 is a right side elevation view of the slideable triple row brush tool of the dental cleaning tool.

FIG. 64 is a perspective view of the slideable triple row brush tool of the dental cleaning tool.

FIGS. 65 and 66 are left and right side perspectives of one suitable embodiment of a dental cleaning tool including a detachable toothpick tool and detachable brush tool, both the detachable toothpick tool and the detachable brush tool being in a first, stow position.

FIG. 67 is a left side elevation of the dental cleaning tool showing the detachable brush tool in a first, stow position.

FIG. 68 is a right side elevation of the dental cleaning tool showing the detachable toothpick tool in a first, stow position.

FIG. 69 is a bottom view of the dental cleaning tool.

FIG. 70A is a top cross-sectional view of the dental cleaning tool with the detachable toothpick tool and the detachable brush tool in a first, stow position.

FIG. 70B is a front cross-sectional view of the dental cleaning tool with the detachable toothpick tool and the detachable brush tool in a first, stow position.

FIG. 71 is an exploded perspective view of the dental cleaning tool showing the detachable toothpick tool and the detachable brush tool spaced from the dental cleaning tool.

FIG. 72 is a right side exploded perspective view of the dental cleaning tool showing the detachable toothpick tool and the detachable brush tool spaced from the dental cleaning tool.

FIG. 72A is an enlarged, cross sectional view taken from FIG. 72.

FIG. 73 is a left side elevation view of the dental cleaning tool showing the detachable toothpick tool and the detachable brush tool detached.

FIG. 74 is a right side elevation view of the dental cleaning tool showing the detachable toothpick tool and the detachable brush tool detached.

FIG. 75 is a side elevation view of the detachable toothpick tool of the dental cleaning tool.

FIG. 76 is a top view of the detachable toothpick tool of the dental cleaning tool.

FIG. 77 is a perspective view of the detachable toothpick tool of the dental cleaning tool.

FIG. 78 is a side elevation view of the detachable brush tool of the dental cleaning tool.

FIG. 79 is a top view of the detachable brush tool of the dental cleaning tool.

FIG. 80 is a perspective view of the detachable brush tool of the dental cleaning tool.

FIG. 81 is a side elevation view of the detachable triple row brush tool suitable for use with the dental cleaning tool.

FIG. 82 is a top view of the detachable triple row brush tool of the dental cleaning tool.

FIG. 83 is a perspective view of the detachable triple row brush tool of the dental cleaning tool.

### DETAILED DESCRIPTION OF THE DRAWINGS

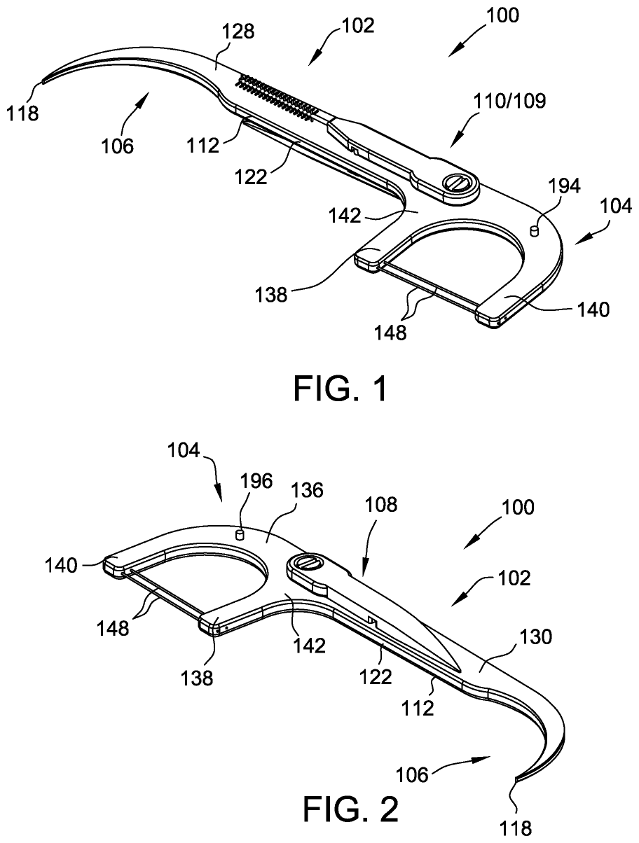

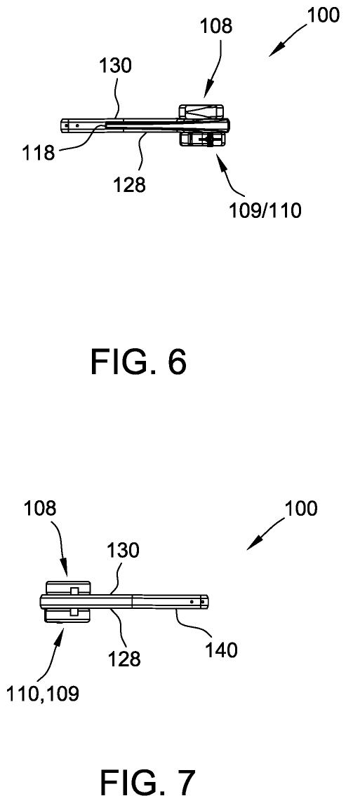

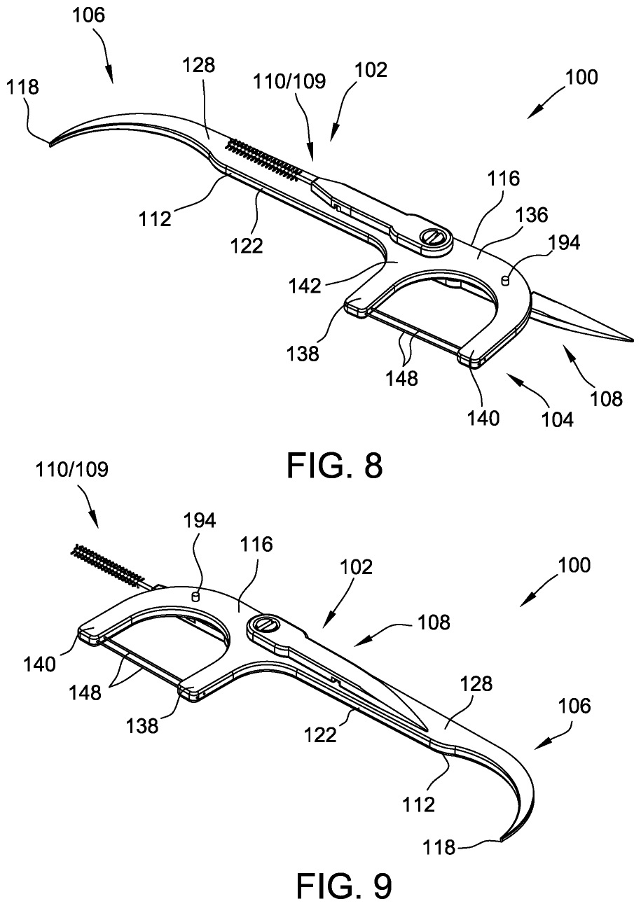

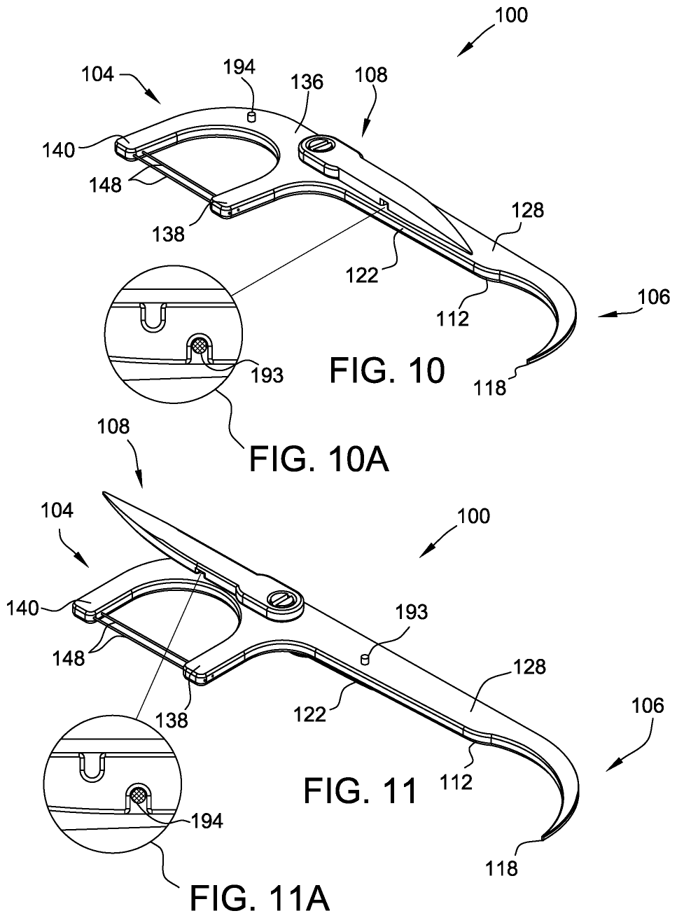

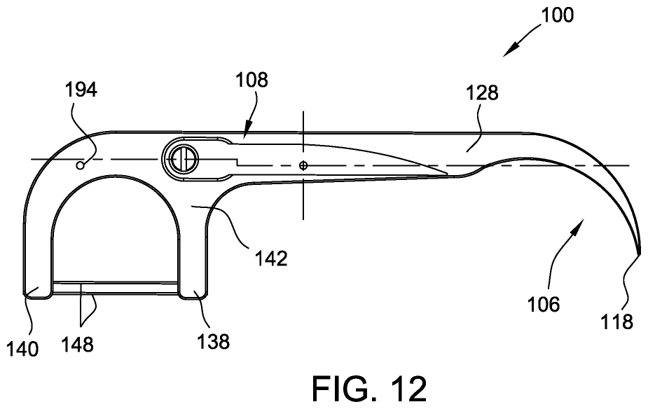

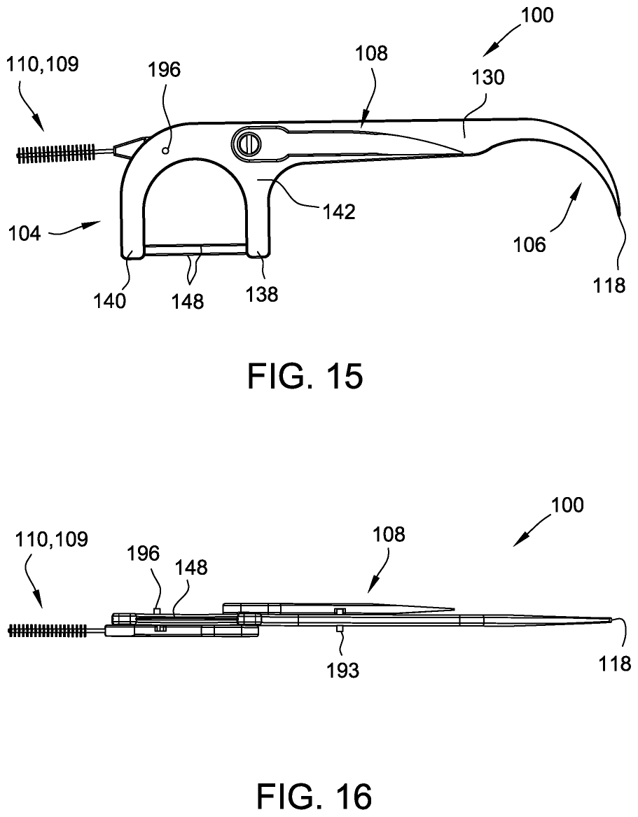

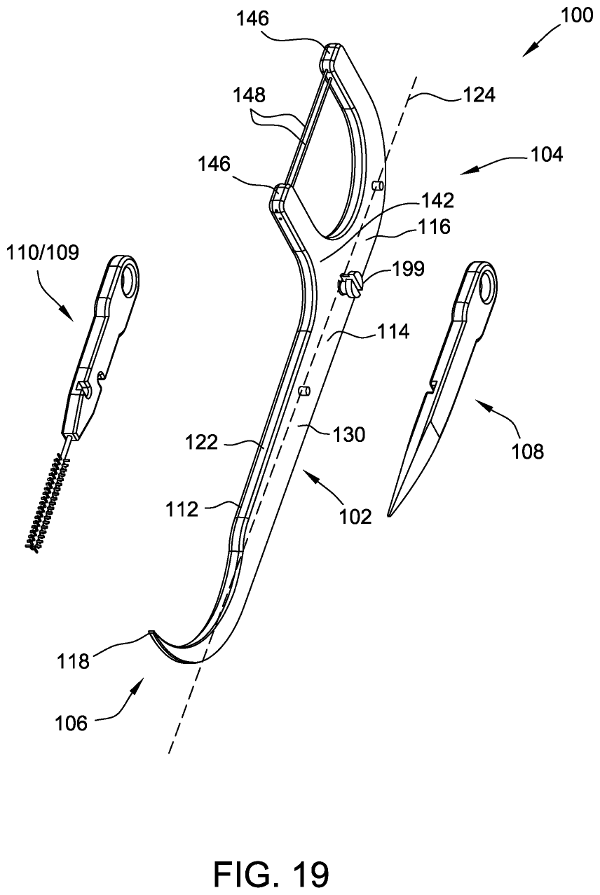

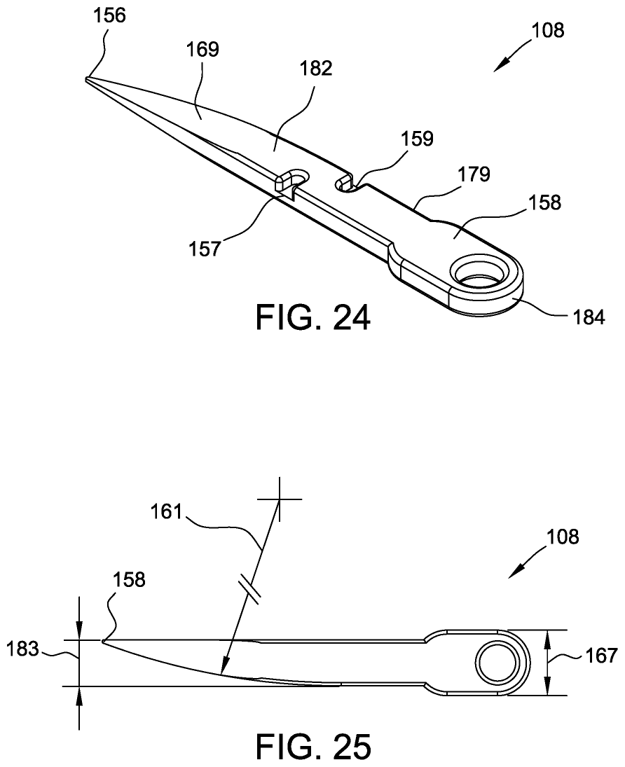

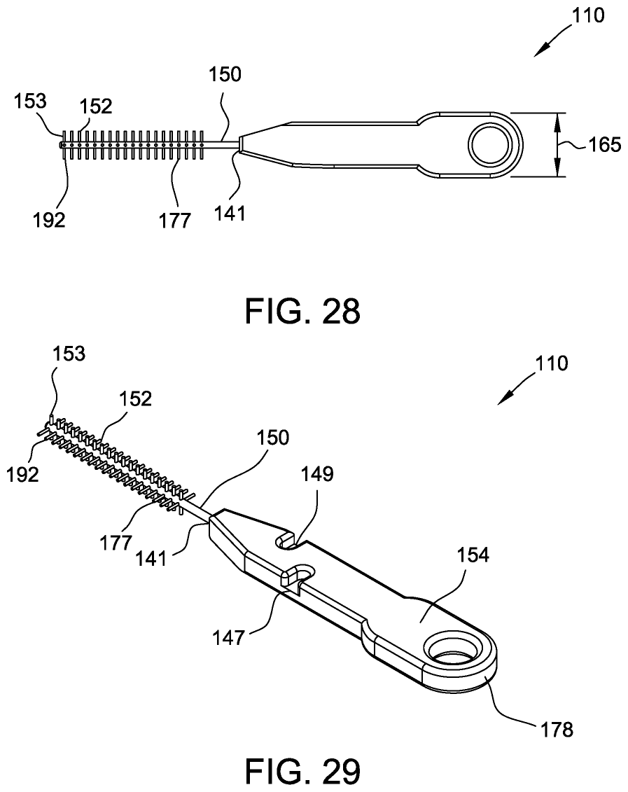

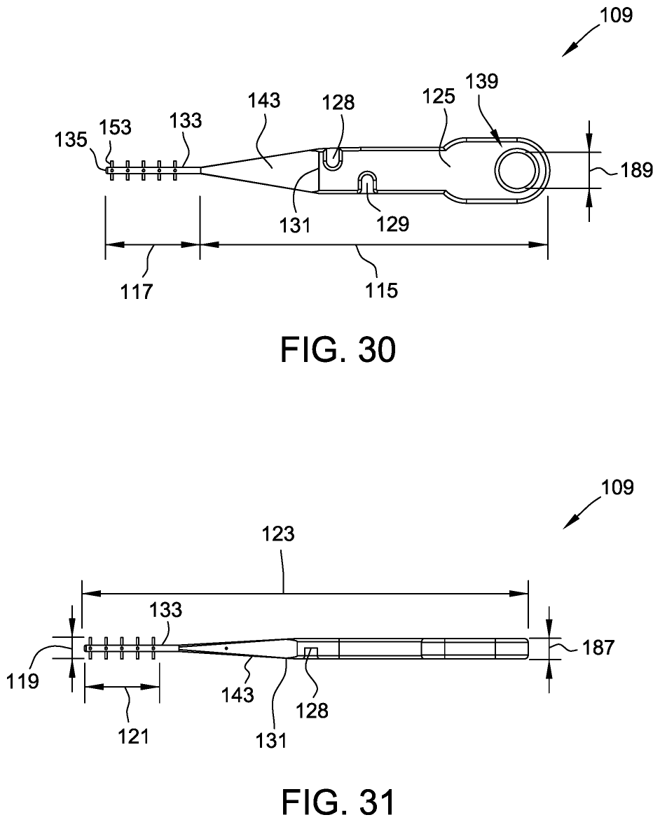

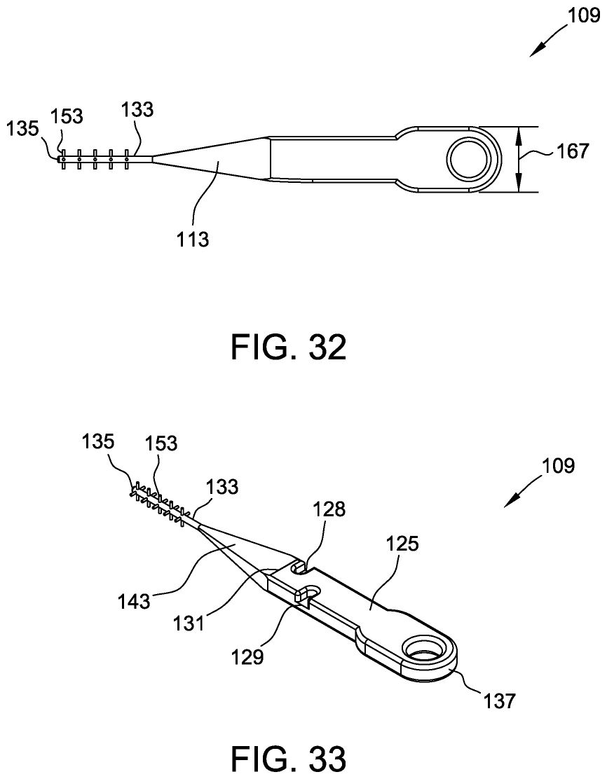

FIGS. 1-29 illustrate one suitable embodiment of a dental cleaning tool, indicated generally at 100, of the present disclosure. As seen therein, the illustrated dental cleaning tool 100 includes a handle 102, a floss holder 104, an integrally formed toothpick 106, a rotatable toothpick tool 108, and a rotatable brush tool 110. FIGS. 30-33 illustrate another suitable embodiment of a rotatable tool that may be attached to dental cleaning tool 100—a rotatable triple row brush tool 109. The handle 102, the floss holder 104, the integrally formed toothpick 106, the rotatable toothpick tool 108, the rotatable brush tool 110, and the rotatable triple row brush tool 109 are each indicated generally by their respective reference number in the accompanying figures. It is understood that in some other suitable embodiments that do not depart from some of the aspects of this disclosure, the dental cleaning tool 100 may include any combination(s) of the floss holder 104, the toothpick 106, the rotatable toothpick tool 108, the rotatable brush tool 110, and the rotatable triple row brush tool 109. It is further contemplated that the dental cleaning tool 100 can include a single tool (i.e., only one of the rotatable toothpick tool 108, the rotatable brush tool 110, and the rotatable triple row brush tool 109) without departing from some aspects of this disclosure.

As illustrated in FIGS. 1-9, the handle 102 includes a grip portion 114, a floss end 116, and a pick end 118. In the illustrated embodiment, the handle 102 has a length 120 measured between the floss end 116 and the pick end 118 along a longitudinal axis 124 of the dental cleaning tool 100, which extends through the handle 102. In suitable embodiments, the length 120 of the handle 102 may be any measurement that enables the dental cleaning tool 100 to function as described herein. Suitably, the length 120 is in the range between about 43 mm and about 52 mm. In the illustrated embodiment, for example, the length 120 of the handle 102 is approximately 48 mm.

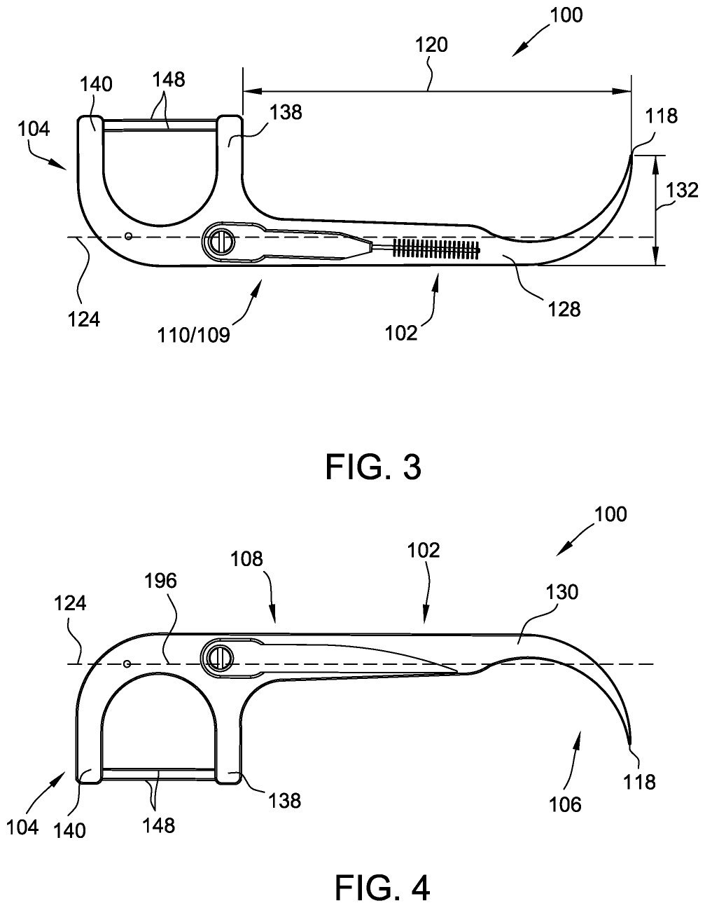

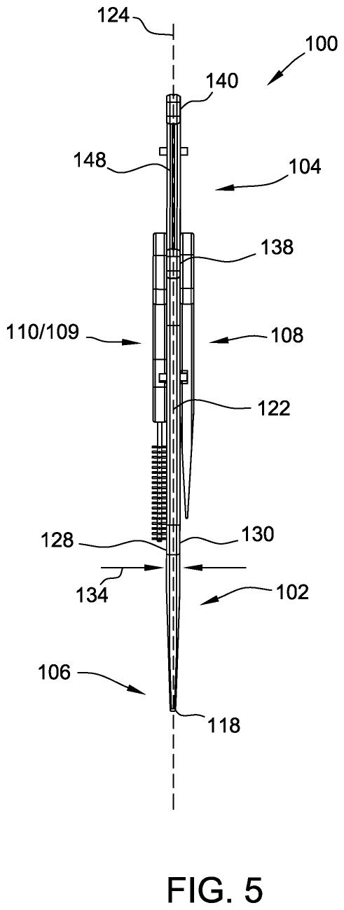

In the illustrated embodiment and as best seen in FIGS. 1-9, the handle 102 includes a front wall 122, an opposing rear wall 126, a first side wall 128, and a second side wall 130 opposite the first side wall. As illustrated in FIGS. 1-9, the side walls 128, 130 are oriented perpendicularly to and connect the front wall 122 and rear walls 126. A width 132 (FIGS. 3 and 4) is measured between the front wall 122 and the rear wall 126 and a thickness 134 (FIG. 5) is measured between the two side walls 128, 130. Suitably, the width 132 of the handle 102 is in the range between about 3.8 mm and about 5.8 mm. In the illustrated embodiment, for example, the width 132 is approximately 4.8 mm. Suitably, the thickness 134 of the handle 102 is in the range between about 1.5 mm and about 2.8 mm. In the illustrated embodiment, for example, the thickness 134 is approximately 1.9 mm.

The toothpick 106, which defines a distal end portion of the handle 102 and, more specifically, defines the pick end 118 of the handle, facilitates removing and/or loosening debris such as food remnants between the user's teeth. It is contemplated that the toothpick 106 can have any suitable shape that facilitates the removal of debris between adjacent teeth. In the illustrated embodiment, the pick end 118 of the handle 102 is pointed to define the toothpick 106. Specifically, the width of at least of the side walls 128, 130 tapers to a point towards the pick end 118. In the illustrated embodiment, as best seen in FIGS. 1-9, both the first side wall 128 and the second side wall 130 taper towards the pick end 118. As a result, the front wall 122 and the rear wall 126 meet at the pick end 118. It is understood that only one of the side walls 128, 130 could taper. For example, in another suitable embodiment, only the second side wall 130 could taper and, in such an embodiment, the first side wall 128 would be generally planar. Additionally, in the illustrated embodiment, the toothpick 106 curves in the direction the floss holder 104 arms curve. It is also contemplated that the toothpick 106 may curve in any other suitable direction, or may be straight.

In the illustrated embodiment, the toothpick 106 is formed as a single piece with the handle 102. In other words, the toothpick 106 is an integral extension of the handle 102. It is understood, however, that the toothpick 106 can be formed as a separate component and attached to the handle 102 during assembly of the dental cleaning tool 100. It is also contemplated that the toothpick 106 can be removably attached to the dental cleaning tool 100 in other suitable embodiments without departing from some aspects of this disclosure.

In the illustrated embodiment, the floss holder 104 extends from the floss end 116 of the handle 102. The floss holder 104 includes an arcuate (or broadly, nonlinear) base 136 and two arms (an inner arm 138 and an outer arm 140) extending in spaced relationship from each other from the base. As seen in FIGS. 3 and 4, the inner arm 138 and the outer arm 140 are substantially parallel relative to each other. The floss holder 104 in the illustrated embodiment is generally U-shaped. However, it is understood that in other suitable embodiments, the floss holder 104 may have any suitable shape.

In the illustrated embodiment, the floss holder 104 is formed as a single-piece with the handle 102. In other words, the floss holder 104 is an integral extension of the handle 102. It is understood, however, that the floss holder 104 can be formed as a separate component and attached to the handle 102 during assembly of the dental cleaning tool 100.

With reference still to FIGS. 3 and 4, the dental cleaning tool 100 includes a curved portion 142 extending between the handle 102 and the floss holder 104. As a result, in the illustrated embodiment, a majority of the base 136 of the floss holder 104 is disposed below the longitudinal axis 124 of the dental cleaning tool 100. The curved portion 142 facilitates the user gripping the handle 102 and positioning the floss holder 104 in the user's mouth. It is understood that the floss holder 104 can be oriented in any manner in relation to the handle 102 that enables the floss holder 104 to function as described herein. For example, the curved portion 142 can be omitted in some suitable embodiments. In such embodiments, the base 136 of the floss holder 104 would be aligned with the longitudinal axis 124 of the dental cleaning tool 100. Further, in the illustrated embodiment, a ridge 112 extends about the perimeter of the dental cleaning tool 100 to provide additional strength to the dental cleaning tool 100 and facilitate a user gripping the dental cleaning tool 100.

Each of the inner and outer arms 138, 140, which are cantilevered with respect to base 136, includes a proximal portion 144 and a distal portion 146. The proximal portions 144 are connected to the base 136 and the distal portions 146 are spaced from the base 136. At least one floss strand 148 extends between the distal portions 146 of the inner and outer arms 138, 140. For example, in the illustrated embodiment, two floss strands 148 extend between the inner and outer arms 138, 140. Suitably, the floss strands 148 are substantially parallel to each other. It is understood that the floss holder 104 may have any suitable configuration without departing from some aspects of this disclosure. For example, the floss strands 148 may be selectively removable from the inner and outer arms 138, 140 such that the user can manually remove and/or replace the floss strands 148.

In one suitable embodiment, at least one of the rotatable toothpick tool 108 and the rotatable brush tool 110 are rotatably mounted to the handle 102 of the dental cleaning tool 100 (FIGS. 1-18). In the illustrated embodiment, both the rotatable toothpick tool 108 and the rotatable brush tool 110 are rotatably mounted to the handle 102 of the dental cleaning tool 100. In another suitable embodiment, the rotatable triple row brush tool 109 (FIGS. 30-33) can be rotatably mounted to the handle 102 of the dental cleaning tool 100 instead of one of or both of the rotatable toothpick tool 108 and the rotatable brush tool 110. Suitably, the rotatable toothpick tool 108, the rotatable triple row brush tool 109, and the rotatable brush tool 110 extend in planes substantially parallel to the longitudinal axis 124 of the tool, each along one of the first side wall 128 and the second side wall 130. In the illustrated embodiments, the rotatable toothpick tool 108 extends along the second side wall 130 and the rotatable brush tool 110 extends along the first side wall 128. In another embodiment, the rotatable triple row brush tool 109 extends along the first side wall 128. It is understood, however, that the rotatable toothpick tool 108, the rotatable triple row brush tool 109, and the rotatable brush tool 110 may extend along any portion of the dental cleaning tool 100 in other suitable embodiments without departing from some aspects of this disclosure.

With reference to FIGS. 1-18, the rotatable toothpick tool 108 includes a pointed tip distal end 156 and a base portion 158. More generally, the rotatable toothpick tool 108 is rotatably mounted to and extends along the handle 102. More specifically, the rotatable toothpick tool 108 is rotatably mounted to and extends along the second side wall 130. In the illustrated embodiment, the rotatable toothpick 108 extends beyond the transverse extent of the floss holder 104 when in a fully rotated position. That is, the rotatable toothpick 108 extends transversely along the longitudinal axis 124 a greater distance than the base 136 of the floss holder 104. As seen in FIG. 5, the illustrated rotatable toothpick tool 108 is disposed, in its entirety, along the second side wall 130.

With reference to FIGS. 1-18 and 26-29, the rotatable brush tool 110 includes a rod 150 and a plurality of bristles 152 extending from the rod 150. More generally, the rotatable brush tool 110 is rotatably mounted to and extends along the handle 102. More specifically, the rotatable brush tool 110 is rotatably mounted to and extends along the first side wall 128. In the illustrated embodiment, the rotatable brush tool 110 extends beyond the transverse extent of the floss holder 104 when in a fully rotated position. That is, the rotatable brush tool 110 extends transversely along the longitudinal axis 124 a greater distance than the base 136 of the floss holder 104. As in in FIG. 5, the illustrated rotatable brush tool 110 is disposed, in its entirety, along the first side wall 128.

With reference to FIG. 30-33, the rotatable triple row brush tool 109 includes a rod 113 and a plurality of bristles 133 extending from the rod 113. In another suitable embodiment, more generally, the rotatable triple row brush tool 109 is rotatably mounted to and extends along the handle 102. More specifically, the rotatable triple row brush tool 109 can be rotatably mounted to and along the first side wall 128. In such an embodiment, the rotatable triple row brush tool 109 extends beyond the transverse extent of the floss holder 104 when in a fully rotated position. That is, the rotatable triple row brush tool 109 extends transversely along the longitudinal axis 124 a greater distance than the base 136 of the floss holder 104. As in in FIG. 5, the rotatable triple row brush tool 109 is disposed, in its entirety, along the first side wall 128.

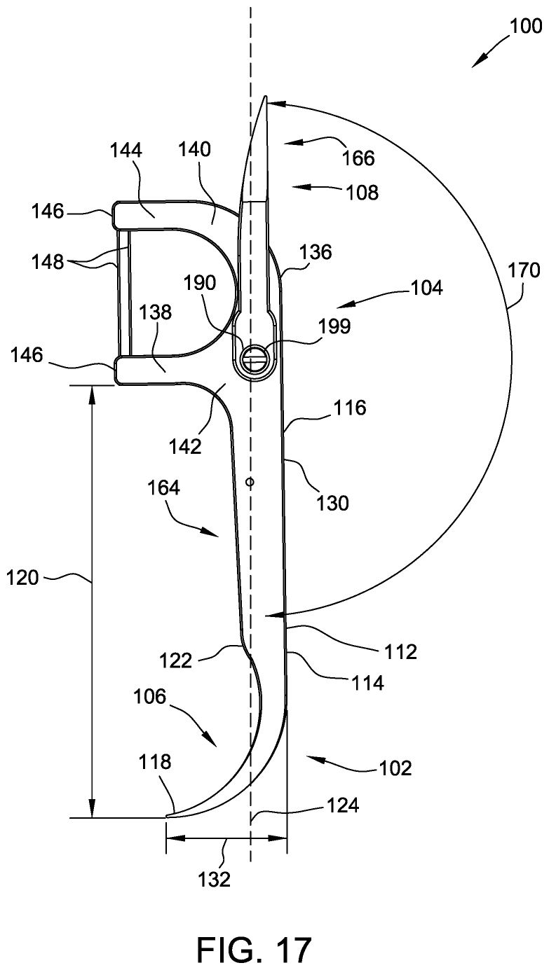

The rotatable toothpick tool 108 is selectively rotatable between a first position 164 (e.g., a stow position) and a second position 166 (e.g., a use position). As shown in FIG. 4, when the rotatable toothpick tool 108 is in the first position 164, the rotatable toothpick tool 108 is generally parallel to the longitudinal axis 124 and the rotatable toothpick tool pointed tip 156 is disposed towards the pick end 118. As illustrated in FIG. 17, the rotatable toothpick tool 108 is rotatable to a plurality of varying positions, each position making an angle 170 with respect to the longitudinal axis 124. In the example embodiment and as seen in FIG. 17, the angle 170 is variable depending on how much the rotatable toothpick tool 108 is rotated away from the handle 102. More specifically, in one suitable embodiment, the angle 170 is variable from about 0° to about 180°. However, it is understood that the angle 170 may extend beyond 180° in some embodiments without departing from the scope of the disclosure. Moreover, it is understood that the rotatable toothpick tool 108 may be angled in relation to any portions of the dental cleaning tool 100 without departing from some aspects of this disclosure.

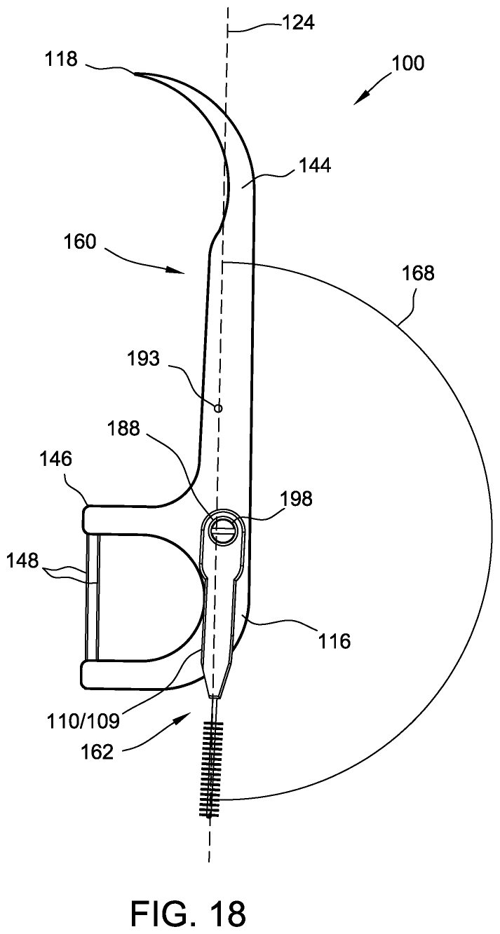

The rotatable brush tool 110 is selectively rotatable between a first position 160 (e.g., a stow position) and a second position 162 (e.g., a use position). As shown in FIG. 3, when the rotatable brush tool 110 is in the first position 160, the rotatable brush tool 110 is generally parallel to the longitudinal axis 124 and the rotatable brush tool distal end 180 is disposed towards the pick end 118. As illustrated in FIG. 18, the rotatable brush tool 110 is rotatable to a plurality of varying positions, each position making an angle 168 with respect to the longitudinal axis 124. In the example embodiment and as seen in FIG. 18, the angle 168 is variable depending on how much the rotatable brush tool 110 is rotated away from the handle 102. More specifically, in one suitable embodiment, the angle 168 is variable from about 0° to about 180°. However, it is understood that the angle 168 may extend beyond 180° in some embodiments without departing from the scope of the disclosure. Moreover, it is understood that the rotatable brush tool 110 may be angled in relation to any portions of the dental cleaning tool 100 without departing from some aspects of this disclosure.

The rotatable triple row brush tool 109 can also be selectively rotatable between a first position 160 (e.g., a stow position) and a second position 162 (e.g., a use position). When the rotatable triple row brush tool 109 is in the first position 160, the rotatable triple row brush tool 109 is generally parallel to the longitudinal axis 124 and the rotatable triple row brush tool distal end 135 is disposed towards the pick end 118. The rotatable triple row brush tool 109 is rotatable to a plurality of varying positions in another suitable embodiment, each position making an angle 168 with respect to the longitudinal axis 124. The angle 168 is variable depending on how much the rotatable triple row brush tool 109 is rotated away from the handle 102. More specifically, in one suitable embodiment, the angle 168 is variable from about 0° to about 180°. However, it is understood that the angle 168 may extend beyond 180° in some embodiments without departing from the scope of the disclosure. Moreover, it is understood that the rotatable triple row brush tool 109 may be angled in relation to any portions of the dental cleaning tool 100 without departing from some aspects of this disclosure.

The rotatable toothpick tool 108, the rotatable triple row brush tool 109, and the rotatable brush tool 110 may extend from any portion of the handle 102. In the illustrated embodiment, the rotatable brush tool 110 extends in a plane generally parallel to the longitudinal axis 124 along the first side wall 128 of the handle 102. In another suitable embodiment, the rotatable triple row brush tool 109 extends in a plane generally parallel to the longitudinal axis 124 along the first side wall 128 of the handle 102. Additionally, in the illustrated embodiment, the rotatable toothpick tool 108 extends in a plane generally parallel to the longitudinal axis 124 along the second side wall 130 of the handle 102. In suitable embodiments, the rotatable toothpick tool 108, the rotatable triple row brush tool 109, and the rotatable brush tool 110 may be oriented in any manner without departing from some aspects of this disclosure.

Once the rotatable toothpick tool 108 is selectively rotated to a second, use position 166, which in the current embodiment corresponds to the angle 170 of about 180°, and a second position catch 159 of the rotatable toothpick tool 108 has engaged a second side second position nub 196 as explained further below, the user can comfortably use the rotatable toothpick tool 108 to clean their teeth. In particular, the user can comfortably hold the handle 102 and position the rotatable toothpick tool 108 between their teeth without having to awkwardly position their hand in relation to their mouth or awkwardly position the dental cleaning tool 100 within their mouth. Additionally, the rotatable toothpick tool 108 facilitates the dental cleaning tool 100 to reach difficult locations in a user's mouth (i.e., the back of the user's mouth). Moreover, the dental cleaning tool 100 is configured such that the rotatable toothpick tool 108 can be positioned in a variety of positions without being obstructed by the floss holder 104 and vice-versa.

Additionally, when the rotatable brush tool 110 is selectively rotated to the second position 162, which in the current embodiment corresponds to the angle 168 of about 180°, and the second position catch 147 of the rotatable brush tool 110 has engaged the second position nub 194, the user can comfortably use the rotatable brush tool 110 to clean their teeth. In particular, the user can comfortably hold the handle 102 and position the rotatable brush tool 110 against various surfaces of their teeth without having to awkwardly position their hand in relation to their mouth or awkwardly position the dental cleaning tool 100 within their mouth. Additionally, the rotatable brush tool 110 enables the dental cleaning tool 100 to reach difficult locations in a user's mouth (i.e., the back of the user's mouth). Moreover, the dental cleaning tool 100 is configured such that the rotatable brush tool 110 can be positioned in a variety of positions without being obstructed by the floss holder 104 and vice-versa.

In another embodiment, when the rotatable triple row brush tool 109 is selectively rotated to the second position 162, which in the current embodiment corresponds to the angle 168 of about 180°, and the second position catch 127 of the rotatable triple row brush tool 109 has engaged the second position nub 194, the user can comfortably use the rotatable triple row brush tool 109 to clean their teeth. In particular, the user can comfortably hold the handle 102 and position the rotatable triple row brush tool 109 against various surfaces of their teeth without having to awkwardly position their hand in relation to their mouth or awkwardly position the dental cleaning tool 100 within their mouth. Additionally, the rotatable triple row brush tool 109 enables the dental cleaning tool 100 to reach difficult locations in a user's mouth (i.e., the back of the user's mouth). Moreover, the dental cleaning tool 100 is configured such that the rotatable triple row brush tool 109 can be positioned in a variety of positions without being obstructed by the floss holder 104 and vice-versa.

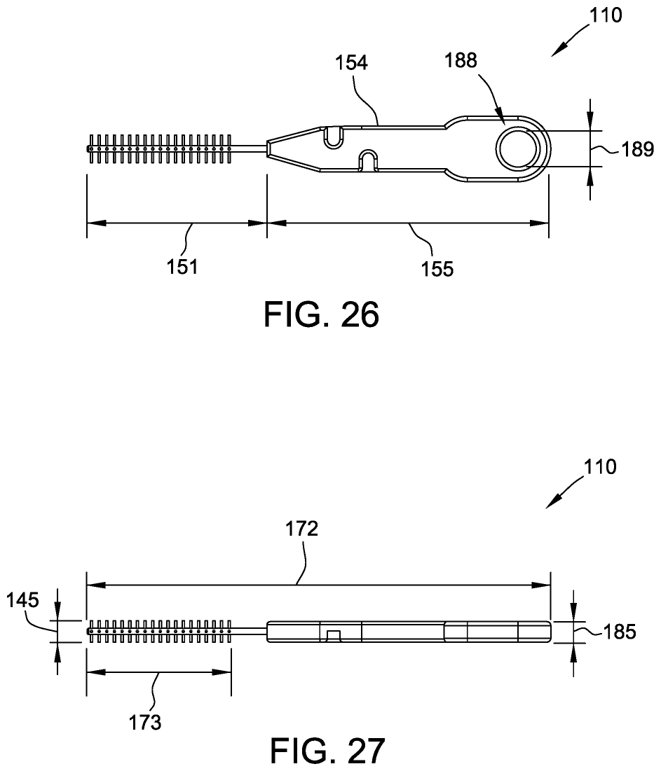

As best illustrated in FIGS. 26-29, the rod 150 of rotatable brush tool 110 has a distal end 180 and extends to the intersection with the base portion distal end 141. A length 151 is measured between the distal end 180 and the base distal end 141. Suitably, the length 151 is between about 10 mm and about 20 mm. In the illustrated embodiment, for example, the length 151 is approximately 15 mm. Suitably, the rod 150 is of a cylindrical shape with a sidewall 177 extending from the base distal end 141 to the distal end 180. In the illustrated embodiment, the sidewall 177 is of a non-tapering cylindrical shape that extends from the base distal end 141 to the distal end 180.

With reference to FIGS. 26-29, the bristles 152 extend from the rod 150 for cleaning the user's teeth. A length 173 is measured from the distal end 180 and the end of the bristles 152. The bristles 152 may be arranged in any suitable manner. In the illustrated embodiment, the bristles 152 are arranged in a plurality of bristle groups 192 spaced along the length of the rod 150 and spaced annularly around the circumference of the rod 150. In other suitable embodiments, the bristles 152 may be continuous along the length and/or circumference of the rod 150 instead of being arranged in the spaced bristle groups 192. Additionally, in suitable embodiments, the bristles 152 may extend from only a portion of the rod 150, e.g., along only side of the rod 150 or only at the distal end 180. In the illustrated embodiment, the bristle groups 192 are arranged in rows extending along the length 151 of the rod 150 that are spaced annularly around the circumference of the rod 150. It is understood that the bristles 152 can be grouped in any suitable manner or can be arranged randomly on the rod 150.

In another embodiment, as best illustrated in FIGS. 30-33, the rod 113 of rotatable triple row brush tool 109 has a distal end 135 and extends to the intersection with the base portion distal end 131. A length 117 is measured between the distal end 180 and the base distal end 131. Suitably, the length 117 is between about 10 mm and about 20 mm. In the illustrated embodiment, for example, the length 117 is approximately 15 mm. Suitably, the rod 113 is of a conical shape with a sidewall 143 extending from the base distal end 131 to the distal end 135. In the illustrated embodiment, the sidewall 143 is of a tapering conical shape that extends from the base distal end 131 to the distal end 135.

With reference to FIGS. 30-33, the bristles 133 extend from the rod 113 for cleaning the user's teeth. A length 121 is measured from the distal end 135 to the end of the bristles 133. The bristles 133 may be arranged in any suitable manner. In the illustrated embodiment, the bristles 133 are arranged in a series of three rows 153 spaced equidistant from each other around the circumference of the rod 113 and spaced apart from each other of the bristles 133 along the length of the rod 113. In other suitable embodiments, the bristles 133 may be continuous along the length and/or circumference of the rod 113 instead of being arranged in the spaced bristle rows 153. Additionally, in suitable embodiments, the bristles 133 may extend from only a portion of the rod 113, e.g., along only side of the rod 113 or only at the distal end 135. In other suitable embodiments, the bristles 133 may be integrally formed with the rod 113. In the illustrated embodiment, the rows 153 are arranged in 3 rows extending along the length 121 of the rod 113 that are spaced annularly around the perimeter of the rod 113. It is understood that the bristles 133 can be grouped in any suitable manner or can be arranged randomly on the rod 113.

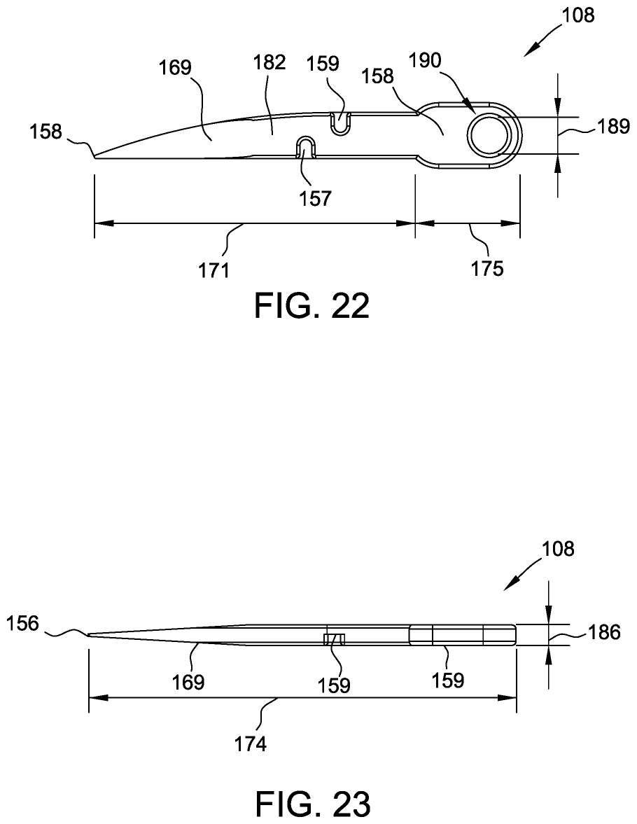

As best illustrated in FIGS. 22-25, the rotatable toothpick tool 108 has a proximal end 184 and a distal end pointed tip 156. A length 174 is measured between the distal end 156 and the proximal end 184. Suitably, the length 174 is between about 27 mm and about 55 mm. In the illustrated embodiment, for example, the length 174 is approximately 40 mm. Suitably, the rotatable toothpick tool 108 has a base 158 of base length 175 extending from the proximal end 184 to a base distal end 179. Pick 169 extends from the base distal end 179 to the distal end 156 and has a length 171 and a sidewall 182. In the illustrated embodiment, the sidewall 182 tapers as it extends from the base 158 to the distal end 156. The sidewall 182 contains a first position catch 157 and a second position catch 159. First position catch 157 interfaces with second side first position nub 191 of tool 100. Second position catch 159 interfaces with second side second position nub 196 of tool 100. The distal end 156 facilitates the distal end 186 being positioned in tight spaces for cleaning purposes. An opening 190 extends through the base 158 and is of a diameter 189 sufficient to engage in a snap-fit relationship with a second side attachment point 199 of the tool 100. The snap-fit relationship between the opening 190 and the attachment point 199 facilitates the rotatable toothpick tool 108 to be manually rotated between the first position 164 and the second position 166. The snap-fit relationship between the opening 190 and the attachment point 199 further facilitates retaining the rotatable toothpick tool 108 alongside the second side wall 130 in both the first position 164 and the second position 166. It is understood that the opening 190 may have any suitable shape and size without departing from some aspects of this disclosure. It is understood that the rotatable toothpick tool 108 may include other suitable rotating components to enable the rotatable toothpick tool 108 to be rotated between the first position 164 and the second position 166, such as non-circular openings or non-snap-fit attachment methods, without departing from at least some aspects of the disclosure.

With reference to FIGS. 26-29, the rotatable brush tool 110 has a base end 178 and a distal end 180. A length 172 is measured between the distal end 180 and the base end 178. Suitably, the length 172 is between about 27 mm and about 55 mm. In the illustrated embodiment, for example, the length 172 is approximately 40 mm. Suitably, the rotatable brush tool 110 has a base 154 of length 155 extending from the base end 178 to the distal end of the base 141. The base 154 is tapered from a point between the distal end of the base 141 and the base end 178 to the distal end 141 of the base 154. The base 154 contains a first position catch 149 and a second position catch 147. First position catch 149 interfaces with first side first position nub 193 of tool 100. Second position catch 147 interfaces with first side second position nub 194 of tool 100. An opening 188 extends through the base 154 and is of a diameter 189 sufficient to engage in a snap-fit relationship with a first side attachment point 198 of the tool 100. The snap-fit relationship between the opening 188 and the attachment point 198 facilitates the rotatable brush tool 110 to be manually rotated between the first position 160 and the second position 162. The snap-fit relationship between the opening 188 and the attachment point 198 further facilitates retaining the rotatable brush tool 110 alongside the first side wall 128 in both the first position 160 and the second position 162. In the illustrated embodiment, the opening 188 is of a substantially circular cross-sectional area. It is understood that the opening 188 may have any suitable shape and size without departing from some aspects of this disclosure. It is further understood that the rotatable brush tool 110 may include other suitable rotating components to enable the rotatable brush tool 110 to be rotated between the first position 160 and the second position 162, such as non-circular openings or non-snap-fit attachment methods, without departing from at least some aspects of the disclosure.

In another suitable embodiment, with reference to FIGS. 30-33, the rotatable triple row brush tool 109 has a base end 137 and a distal end 135. A length 123 is measured between the distal end 135 and the base end 137. Suitably, the length 123 is between about 27 mm and about 55 mm. In the illustrated embodiment, for example, the length 123 is approximately 40 mm. Suitably, the rotatable triple row brush tool 109 has a base 125 of length 115 extending from the base end 137 to the distal end of the base 135. The base 125 is tapered from a point between the base distal end 131 and the base end 137 to the distal end 131 of the base 154. The base 125 contains a first position catch 129 and a second position catch 127. First position catch 129 interfaces with first side first position nub 193 of tool 100. Second position catch 127 interfaces with first side second position nub 194 of tool 100. An opening 139 extends through the base 125 and is of a diameter 189 sufficient to engage in a snap-fit relationship with a first side attachment point 198 of the tool 100. The snap-fit relationship between the opening 139 and the attachment point 198 facilitates the rotatable triple row brush tool 109 to be manually rotated between the first position 160 and the second position 162. The snap-fit relationship between the opening 139 and the attachment point 198 further facilitates retaining the rotatable triple row brush tool 109 alongside the first side wall 128 in both the first position 160 and the second position 162. In the illustrated embodiment, the opening 139 is of a substantially circular cross-sectional area. It is understood that the opening 139 may have any suitable shape and size without departing from some aspects of this disclosure. It is further understood that the rotatable triple row brush tool 109 may include other suitable rotating components to enable the rotatable triple row brush tool 109 to be rotated between the first position 160 and the second position 162, such as non-circular openings or non-snap-fit attachment methods, without departing from at least some aspects of the disclosure.

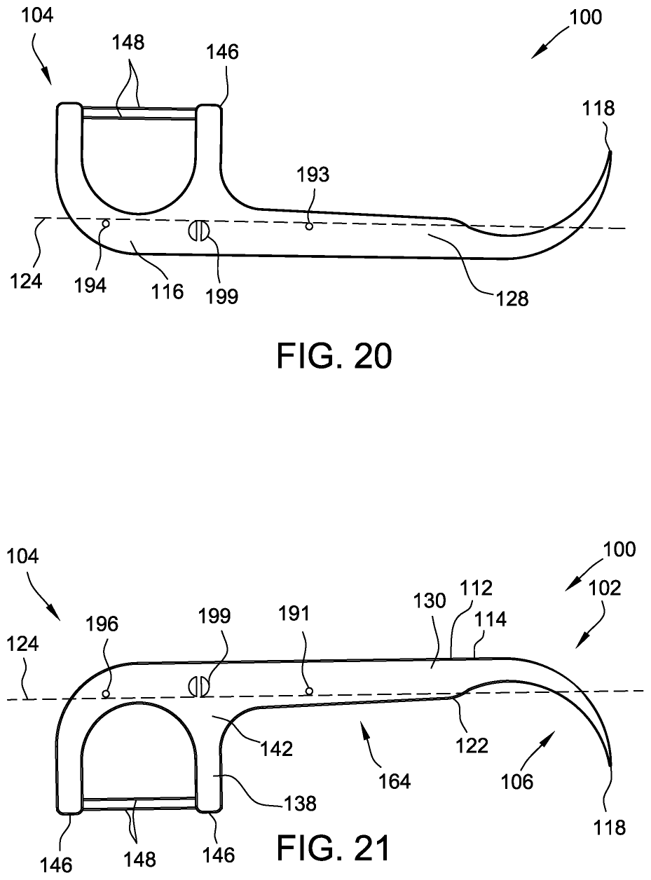

With reference to FIGS. 20 and 21, the first side attachment point 198 extends in a direction substantially perpendicular to the longitudinal axis from the first side wall 128 face of the base 136. Second side attachment point 199 extends in a direction substantially perpendicular to the longitudinal axis from the second side wall face 130 of the base 136. In the illustrated embodiment, first side attachment point 198 and second side attachment point 199 are of a cylindrical shape to facilitate a snap-fit attachment of the rotatable brush tool 110, the rotatable toothpick tool 108, and the rotatable triple row brush tool 109. It is understood that first attachment point 198 and the second attachment point 199 may include other suitable rotating components to enable the rotatable brush tool 110, the rotatable toothpick tool 108, and the rotatable triple row brush tool 109 to be rotated throughout their full range of motion, such as non-cylindrical attachment points or non-snap-fit attachment methods, without departing from at least some aspects of the disclosure.

In suitable embodiments, the dental cleaning tool 100 may be formed in any suitable manner and of any suitable material. For example, the dental cleaning tool 100 may be formed from metal, wood, plastic, and/or combinations thereof. In one preferred embodiment, at least the handle 102, the floss holder 104, and the toothpick 106 of the dental cleaning tool 100 are molded or otherwise formed from a single piece of resilient synthetic material, such as, but not limited to, plastic or metal. In the illustrated embodiment, the handle 102, the floss holder 104, and the toothpick 106 are integrally formed. More specifically in the illustrated embodiment, the dental cleaning tool 100, except for the floss strands 148, the rotatable toothpick tool 108, and the rotatable brush tool 110, is molded as a single piece from acceptable food grade plastic. In other embodiments, any of the handle 102, the floss holder 104, the toothpick 106, the rotatable toothpick tool 108, the rotatable brush tool 110, and the rotatable triple row brush tool 109 may be separately formed and attached to the dental cleaning tool 100 during assembly.

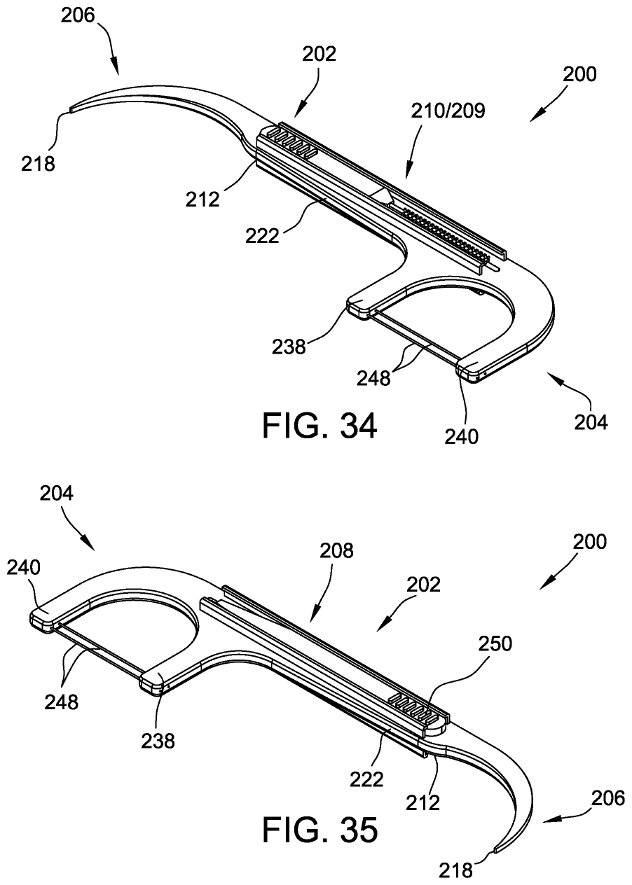

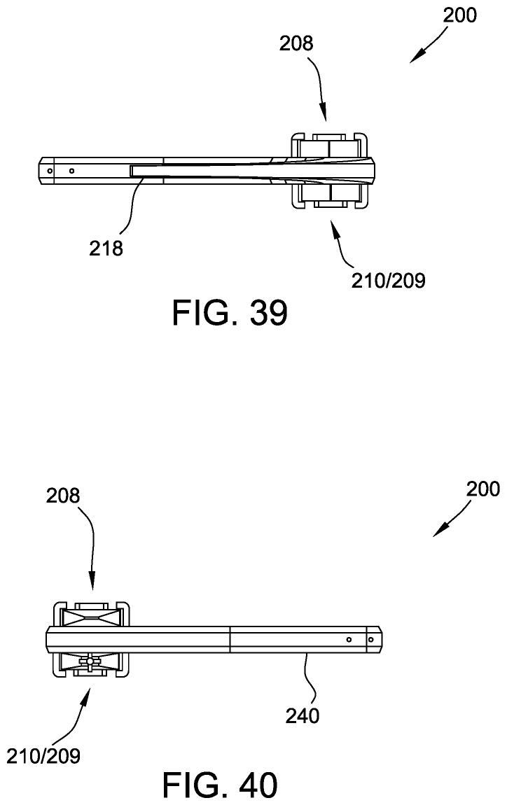

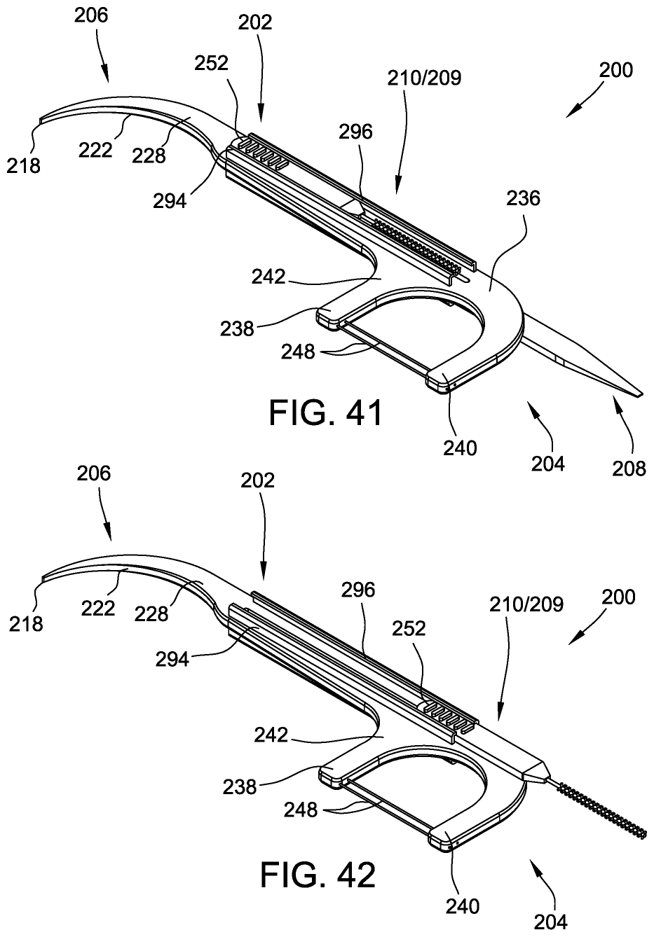

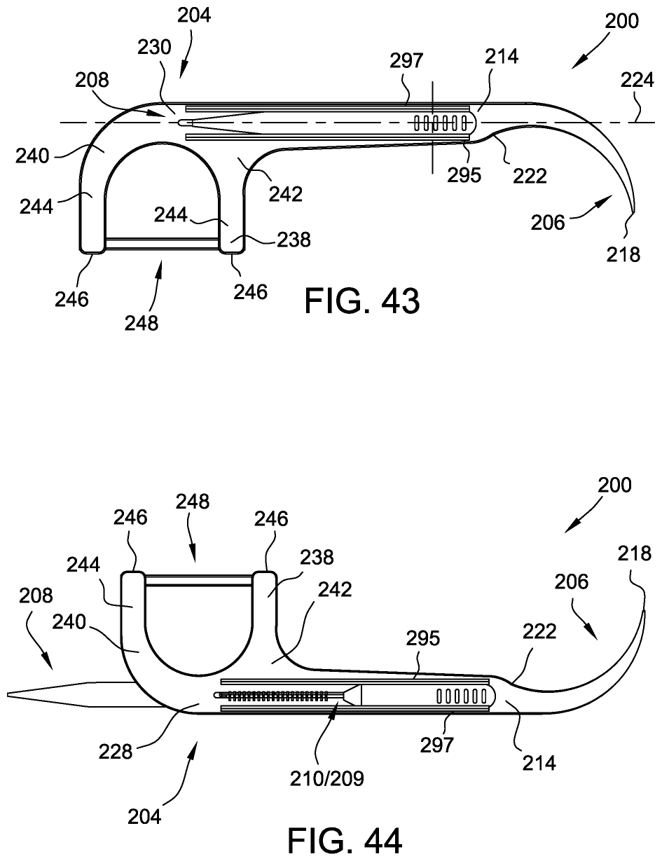

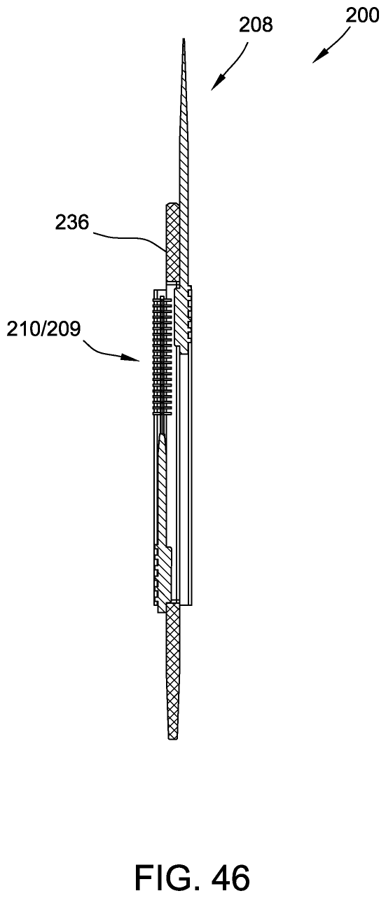

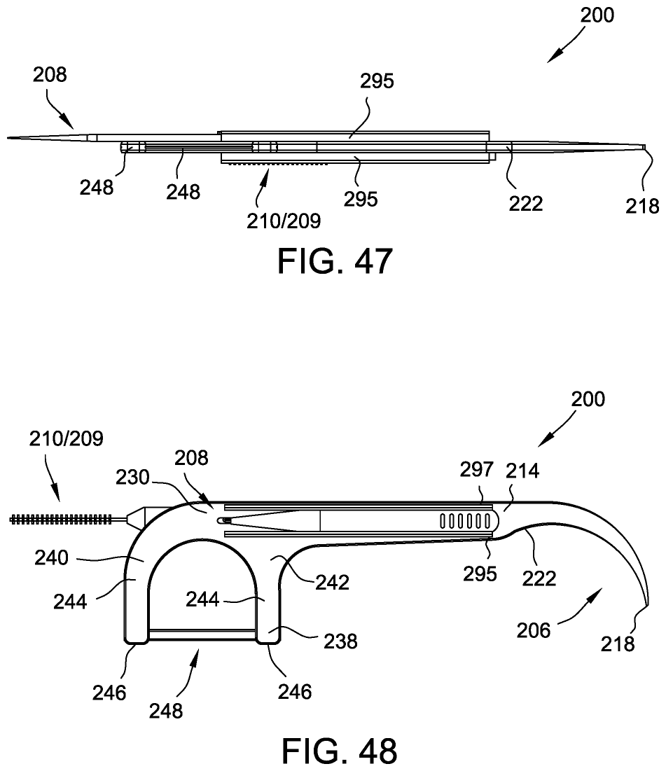

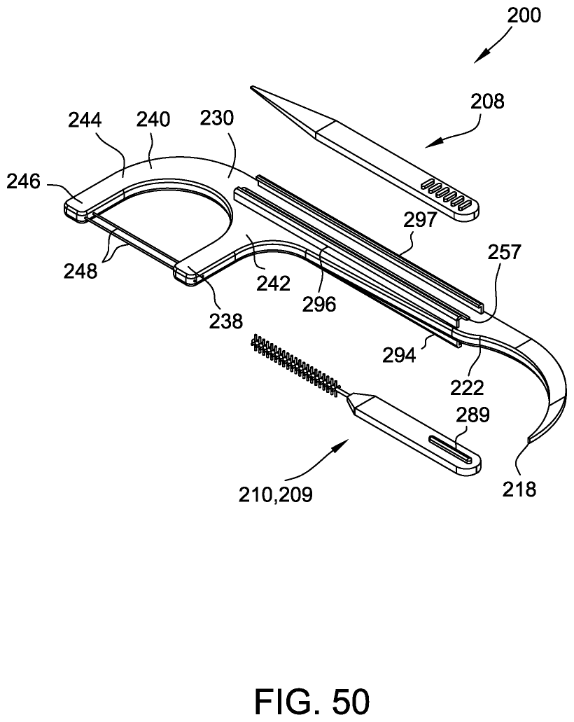

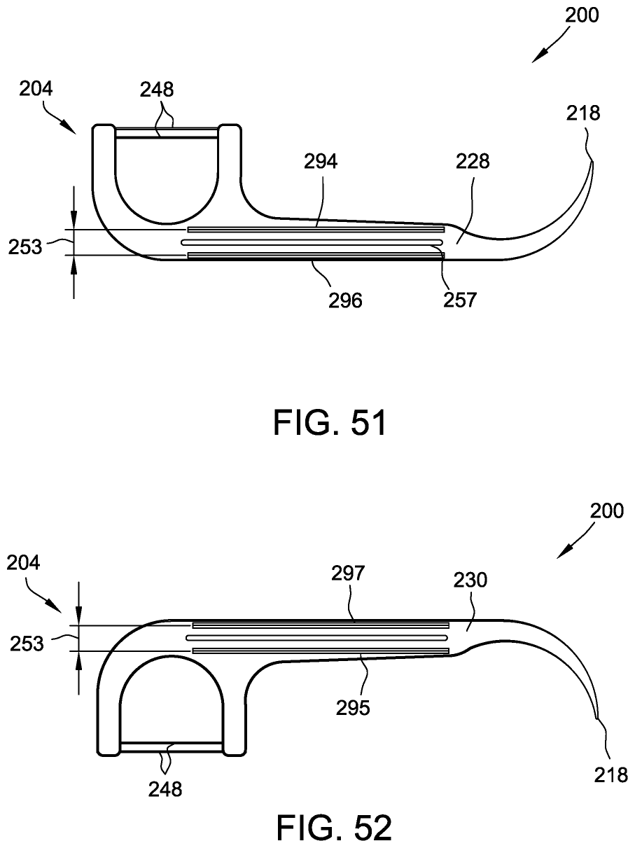

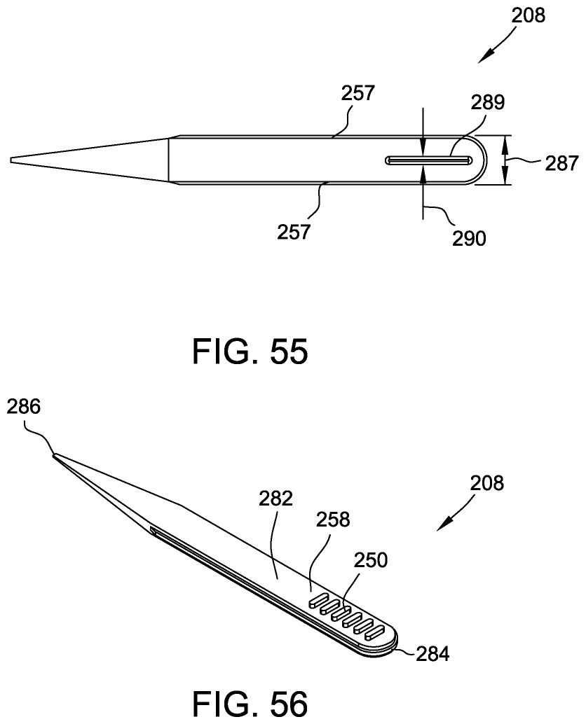

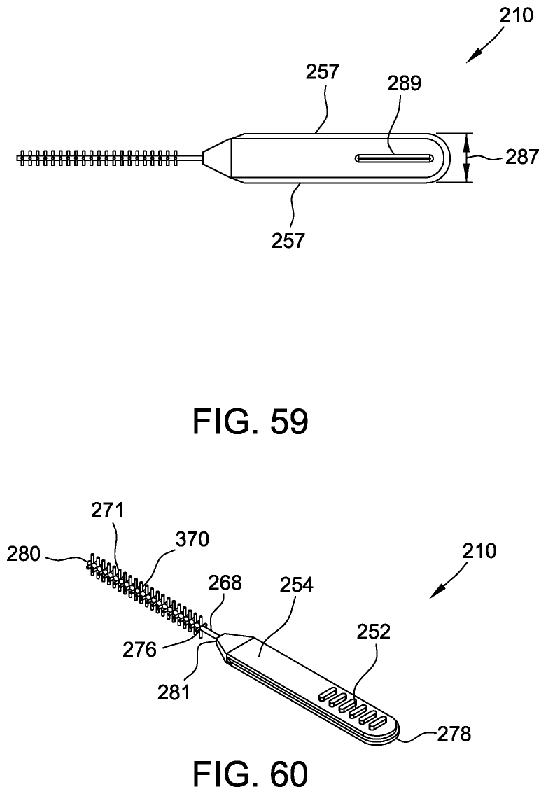

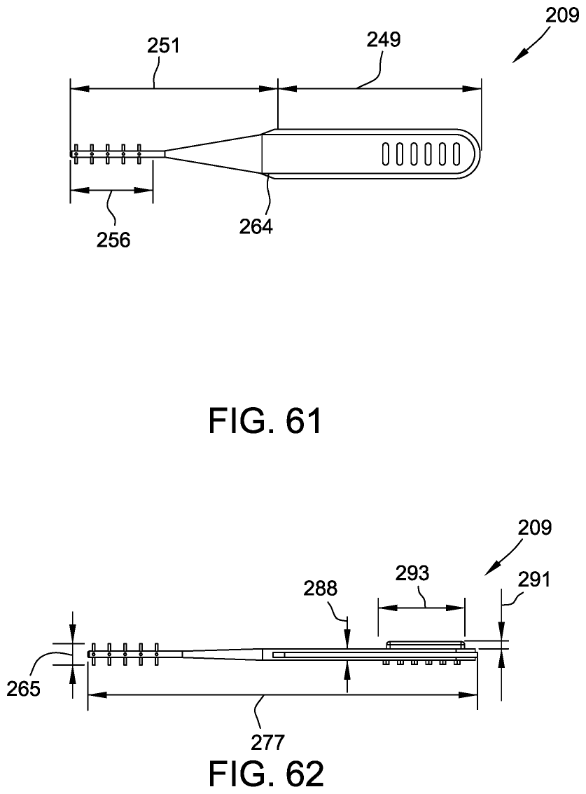

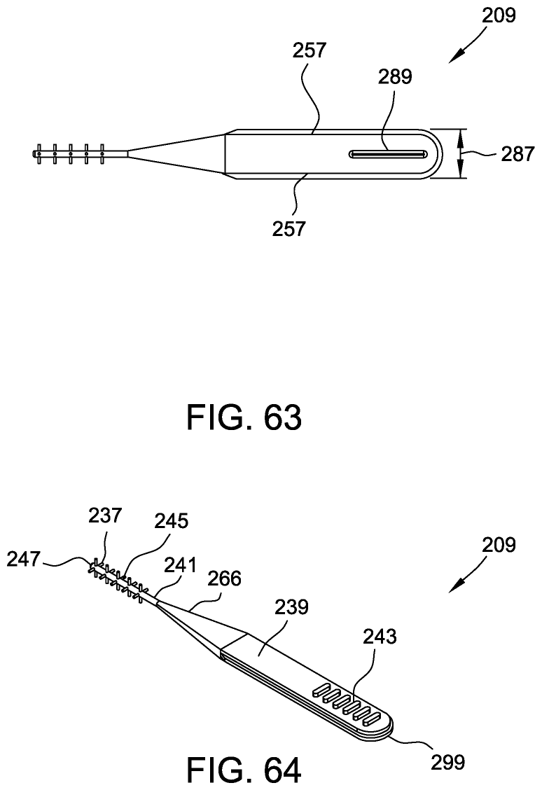

FIGS. 34-60 illustrate another suitable embodiment of a dental cleaning tool, indicated generally at 200. As seen therein, the illustrated dental cleaning tool 200 includes a handle 202, a floss holder 204, an integrally formed toothpick 206, a slideable toothpick tool 208, and a slideable brush tool 210. FIGS. 61-64 illustrate a slideable triple row brush tool 209, which can be used with the dental tool instead of or in additional to one of or both of the slideable toothpick tool 208 and the slideable brush tool 210. The handle 202, the floss holder 204, the integrally formed toothpick 206, the slideable toothpick tool 208, the slideable brush tool 210, and the slideable triple row brush tool 209 are each indicated generally by their respective reference number in the accompanying FIGS. 34-64. It is understood that in some other suitable embodiments that do not depart from some of the aspects of this disclosure, the dental cleaning tool 200 may include any combination(s) of the floss holder 204, the toothpick 206, the slideable toothpick tool 208, the slideable brush tool 210, and the slideable triple row brush tool 209. It is contemplated that in one suitable embodiment the dental cleaning tool 200 can include only one of the slideable toothpick tool 208, the slideable brush tool 210, and the slideable triple row brush tool 209.

As illustrated in FIGS. 34-49, the handle 202 includes a grip portion 214, a floss end 216, and a pick end 218. In the illustrated embodiment, the handle 202 has a length 220 measured between the floss end 216 and the pick end 218 along a longitudinal axis 224 of the dental cleaning tool 200, which extends through the handle 202. In suitable embodiments, the length 220 of the handle 202 may be any measurement that enables the dental cleaning tool 200 to function as described herein. Suitably, the length 220 is in the range between about 43 mm and about 52 mm. In the illustrated embodiment, for example, the length 220 of the handle 202 is approximately 48 mm.

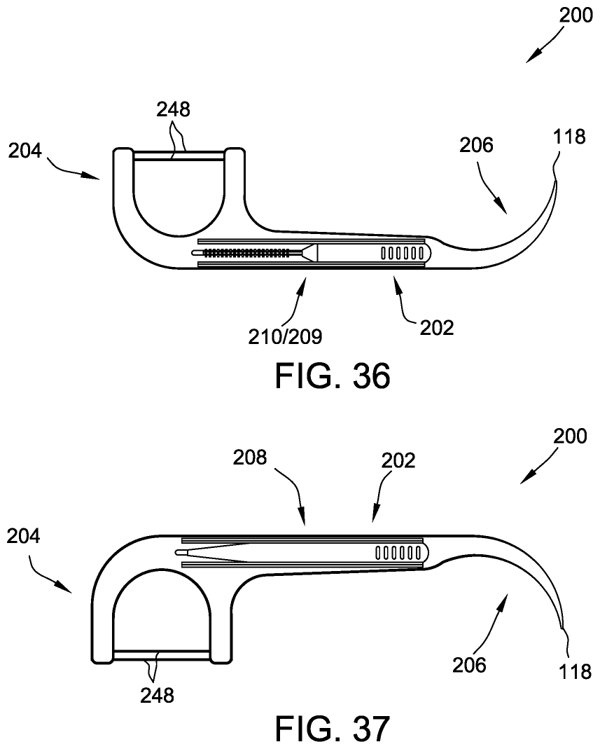

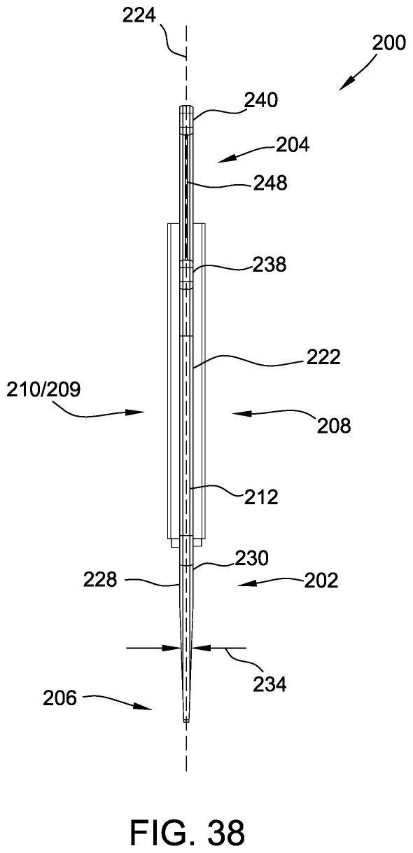

In the illustrated embodiment and as best seen in FIGS. 34-49, the handle 202 includes a front wall 222, an opposing rear wall 226, a first side wall 228, and a second side wall 230 opposite the first side wall. As illustrated in FIG. 36-40, the side walls 228, 230 are oriented perpendicularly to and connect the front and rear walls 222, 226. A width 232 (FIGS. 36 and 37) is measured between the front wall 222 and the rear wall 226 and a thickness 234 (FIGS. 38-40) is measured between the two side walls 228, 230. Suitably, the width 232 of the handle 202 is in the range between about 3.8 mm and about 5.8 mm. In the illustrated embodiment, for example, the width 232 is approximately 4.8 mm. Suitably, the thickness 234 of the handle 202 is in the range between about 1.5 mm and about 2.8 mm. In the illustrated embodiment, for example, the thickness 234 is approximately 1.9 mm.

The toothpick 206, which defines a distal end portion of the handle 202 and, more specifically, defines the pick end 218 of the handle, facilitates removing and/or loosening debris such as food remnants from between the user's teeth. It is contemplated that the toothpick 206 can have any suitable shape that facilitates the removal of debris between adjacent teeth. In the illustrated embodiment, the pick end 218 of the handle 202 is pointed to define the toothpick 206. Specifically, the width of at least of the first side wall 228 and the second side wall 230 tapers to a point towards the pick end 218. In the illustrated embodiment, as best seen in FIG. 38, both the first side wall 228 and the second side wall 230 taper towards the pick end 218. As a result, the front wall 222 and the rear wall 226 meet at the pick end 218. It is understood that only one of the first side wall 228 and the second side wall 230 could taper. For example, in one other suitable embodiment, only the second side wall 230 could taper and, in such an embodiment, the first side wall 228 would be generally planar.

In the illustrated embodiment, a channel 292 extends in the transverse dimension from the first side wall 228 through the handle 202 to the second side wall 230 and extends in the longitudinal dimension from the area of the handle 202 proximate the integral toothpick 206 to the floss holder 204 portion of the dental tool 200. The channel 292 partially defines the path of the slideable brush tool 210, slideable toothpick tool 208, and slideable triple row brush tool 209 as they moves between the first position 260 and the second position 262. A first side front rail 294, a first side rear rail 296, a second side front rail 295, and a second side rear rail 297 engage a pair of slideable tool retention channels 257 to further define the path the slideable brush tool 210, the slideable toothpick tool 208, and the slideable triple row brush tool 209 travel between the first position 260 and the second position 262. The rail 294 and the rail 296 are substantially parallel to each other and to the channel 292. The rail 295 and the rail 297 are substantially parallel to each other and to the channel 292.

In the illustrated embodiment, the channel 292 is sized and configured to receive the slideable tool rib 289. The rib 289 is of a length 293, a width 290, and a height 291, the resulting perimeter sized and configured to substantially interface with the channel 292.

In the illustrated embodiment, the toothpick 206 is formed as a single piece with the handle 202. In other words, the toothpick 206 is an integral extension of the handle 202. It is understood, however, that the toothpick 206 can be formed as a separate component and attached to the handle 202 during assembly of the dental cleaning tool 200. It is also contemplated that the toothpick 206 can be removably attached to the dental cleaning tool 200 in other suitable embodiments without departing from some aspects of this disclosure.

In the illustrated embodiment, the floss holder 204 extends from the floss end 216 of the handle 202. The floss holder 204 includes an arcuate (or broadly, nonlinear) base 236 and two arms (an inner arm 238 and an outer arm 240) extending in spaced relationship from each other from the base. As seen in FIGS. 36 and 37, the inner arm 238 and the outer arm 240 are substantially parallel relative to each other. The floss holder 204 in the illustrated embodiment is generally U-shaped. However, it is understood that in other suitable embodiments, the floss holder 204 may have any suitable shape.

In the illustrated embodiment, the floss holder 204 is formed as a single-piece with the handle 202. In other words, the floss holder 204 is an integral extension of the handle 202. It is understood, however, that the floss holder 204 can be formed as a separate component and attached to the handle 202 during assembly of the dental cleaning tool 200.

With reference still to FIGS. 36 and 37, the dental cleaning tool 200 includes a curved portion 242 extending between the handle 202 and the floss holder 204. As a result, in the illustrated embodiment, a majority of the base 236 of the floss holder 204 is disposed below the longitudinal axis 224 of the dental cleaning tool 200. The curved portion 242 facilitates the user gripping the handle 202 and positioning the floss holder 204 in the user's mouth. It is understood that the floss holder 204 can be oriented in any manner in relation to the handle 202 that enables the floss holder 204 to function as described herein. For example, the curved portion 242 can be omitted in some suitable embodiments. In such embodiments, the base 236 of the floss holder 204 would be aligned with the longitudinal axis 224 of the dental cleaning tool 200. Further, in the illustrated embodiment, a ridge 212 extends about the perimeter of the dental cleaning tool 200 to provide additional strength to the dental cleaning tool 200 and facilitate a user gripping the dental cleaning tool 200.

Each of the inner arm 238 and the outer arm 240, which are cantilevered with respect to base 236, includes a proximal portion 244 and a distal portion 246. The proximal portions 244 are connected to the base 236 and the distal portions 246 are spaced from the base 236. At least one floss strand 248 extends between the distal portions 246 of the inner and outer arms 238, 240. For example, in the illustrated embodiment, two floss strands 248 extend between the inner arm 238 and the outer arm 240. Suitably, the floss strands 248 are substantially parallel to each other. It is understood that the floss holder 204 may have any suitable configuration without departing from some aspects of this disclosure. For example, the floss strands 248 may be selectively removable from the inner arm 238 and the outer arm 240 such that the user can manually remove and/or replace the floss strands 248.

In the exemplary embodiment, the slideable toothpick tool 208 and the slideable brush tool 210 are slidably mounted to the handle 202 of the dental cleaning tool 200. Suitably, the slideable toothpick tool 208 and the slideable brush tool 210 extend in planes substantially parallel to the longitudinal axis 224, each along one of the first side wall 228 and the second side wall 230. In the illustrated embodiment, the slideable toothpick tool 208 extends along the second side wall 230 and the slideable brush tool 210 extends along the first side wall 228. It is understood, however, that the slideable toothpick tool 208 and the slideable brush tool 210 may extend along any portion and side of the dental cleaning tool 200 in other suitable embodiments without departing from some aspects of this disclosure.

In another suitable embodiment, the slideable toothpick tool 208 and the slideable triple row brush tool 209 are slidably mounted to the handle 202 of the dental cleaning tool 200. Suitably, the slideable toothpick tool 208 and the slideable triple row brush tool 209 extend in planes substantially parallel to the longitudinal axis 224, each along one of the first side wall 228 and the second side wall 230. In the illustrated embodiment, the slideable toothpick tool 208 extends along the second side wall 230 and the slideable triple row brush tool 209 extends along the first side wall 228. It is understood, however, that the slideable toothpick tool 208 and the slideable triple row brush tool 209 may extend along any portion and side of the dental cleaning tool 200 in other suitable embodiments without departing from some aspects of this disclosure.

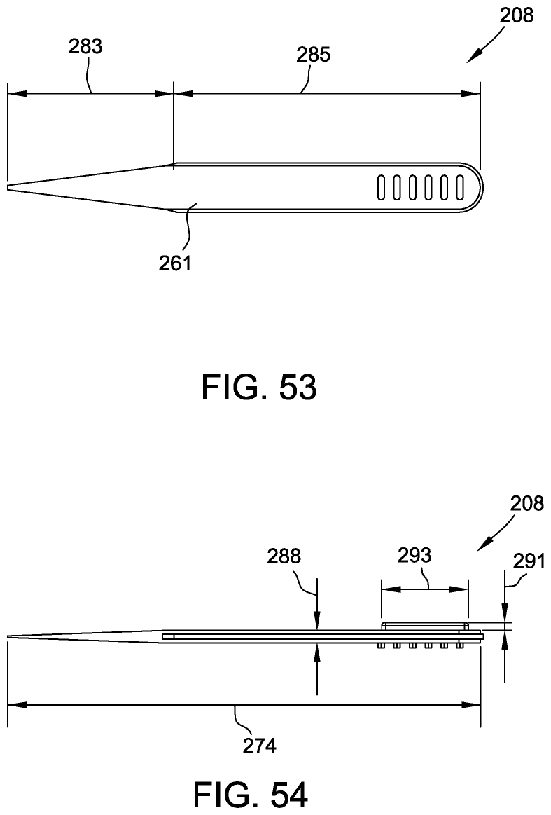

With reference to FIGS. 53-56, the slideable toothpick tool 208 includes a pointed tip 256 and a base portion 258. More generally, the slideable toothpick tool 208 is slidably mounted to and extends along the handle 202. More specifically, the slideable toothpick tool 208 is slidably mounted to and extends along the second side wall 230. In the illustrated embodiment, the slideable toothpick tool 208 extends beyond the transverse extent of the floss holder 204. That is, the slideable toothpick tool 208 extends transversely along the longitudinal axis 224 a greater distance than the base 236 of the floss holder 204. As seen in FIG. 38, the illustrated slideable toothpick tool 208 is disposed, in its entirety, along the second side wall 230.

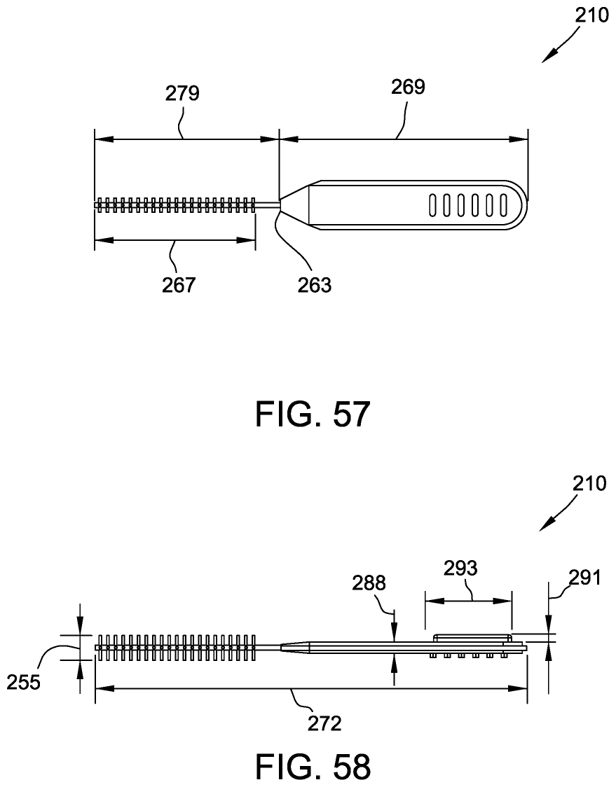

With reference to FIG. 57-60, the slideable brush tool 210 includes a rod 268 and a plurality of bristles 271 extending from the rod 268. More generally, the slideable brush tool 210 is slidably mounted to and extends along the handle 202. More specifically, the slideable brush tool 210 is slidably mounted to and extends along the first side wall 228. In the illustrated embodiment, the slideable brush 210 extends beyond the transverse extent of the floss holder 204. That is, the slideable brush 210 extends transversely along the longitudinal axis 224 a greater distance than the base 236 of the floss holder 204. As in in FIG. 38, the illustrated slideable brush tool 210 is disposed, in its entirety, along the first side wall 228.

In another suitable embodiment, with reference to FIGS. 61-64, the slideable triple row brush tool 209, which is suitable for use with the dental cleaning tool 200, includes a rod 241 and a plurality of bristles 245 extending from the rod 241. More generally, the slideable triple row brush tool 209 is slidably mounted to and extends along the handle 202. More specifically, the slideable triple row brush tool 209 is slidably mounted to and extends along the first side wall 228. In the illustrated embodiment, the slideable triple row brush tool 209 extends beyond the transverse extent of the floss holder 204. That is, the slideable triple row brush tool 209 extends transversely along the longitudinal axis 224 a greater distance than the base 236 of the floss holder 204. When mounted on the dental cleaning tool 200, the slideable triple row brush tool 209 is disposed, in its entirety, along the first side wall 228 (or second side wall 230).

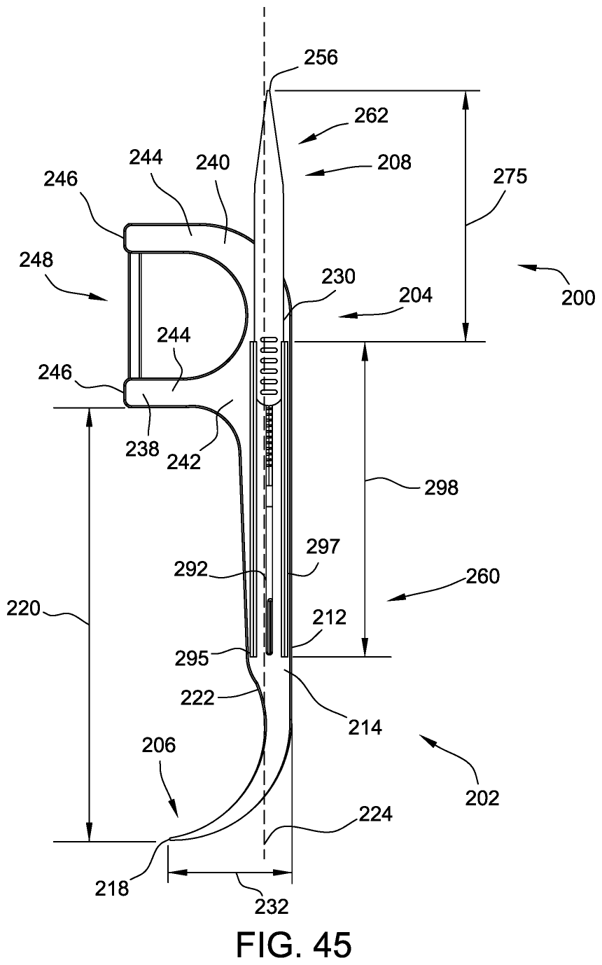

The slideable toothpick tool 208 is selectively slideable between a first position 260 (e.g., a stow position) and a second position 262 (e.g., a use position). As shown in FIG. 37, when the slideable toothpick tool 208 is in the first position 260, the slideable toothpick tool 208 is generally parallel to the longitudinal axis 224 and the slideable toothpick tool pointed tip/distal end 256 is disposed towards the floss holder 204. As illustrated in FIG. 45, the slideable toothpick tool 208 is slideable to a plurality of varying positions, each position defined by a distance 275 from the first position 260. In the example embodiment and as seen in FIG. 45, the distance 275 is variable depending on how much the slideable toothpick tool 208 is slid away from the first position 260. More specifically, in one suitable embodiment, the distance 275 ranges from 0 mm when the slideable toothpick tool 208 is in the first position 260 (FIG. 37), to between about 22 mm and 50 mm when the slideable toothpick tool 208 is in the second position 262 (FIG. 45). For example, the distance 275 as seen in FIG. 45 is approximately 35 mm. Moreover, it is understood that the slideable toothpick tool 208 may be slid to any distance in relation to any portions of the dental cleaning tool 200 without departing from some aspects of this disclosure.

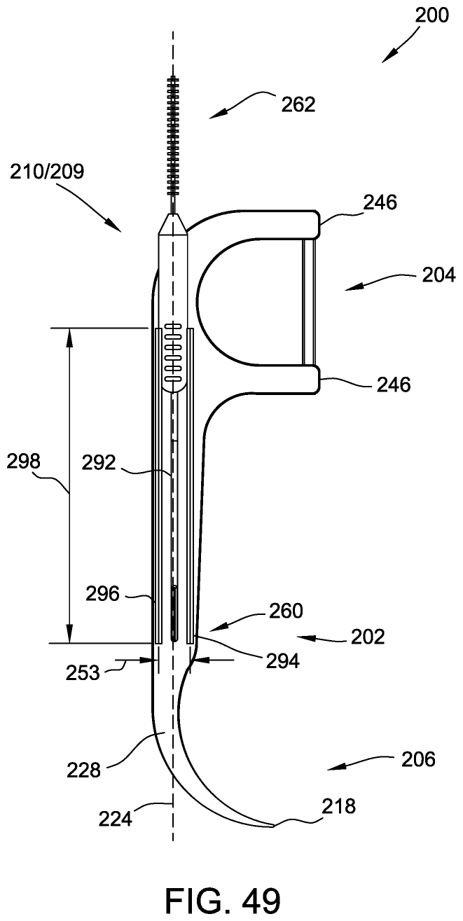

The slideable brush tool 210 is selectively slideable between a first position 260 (e.g., a stow position) and a second position 262 (e.g., a use position). As shown in FIG. 36, when the slideable brush tool 210 is in the first position 260, the slideable brush tool 210 is generally parallel to the longitudinal axis 224 and the slideable brush tool 210 distal end 280 is disposed towards the floss holder 204. As illustrated in FIG. 49, the slideable brush tool 210 is slideable to a plurality of varying positions lying along the channel 292, each position defined by a distance 275 from the first position 260. In the example embodiment and as seen in FIG. 49, the distance 275 is variable depending on how much the slideable brush tool 210 is slid away from the first position 260. More specifically, in one suitable embodiment, the distance 275 ranges from 0 mm when the slideable brush tool 210 is in the first position 260 (FIG. 36), to between about 22 mm and 50 mm when the slideable brush tool 210 is in the second position 262 (FIG. 49). For example, the distance 275 seen in FIG. 49 is approximately 35 mm. Moreover, it is understood that the slideable brush tool 210 may be slid to any distance in relation to any portions of the dental cleaning tool 200 without departing from some aspects of this disclosure.

In another suitable embodiment, the slideable triple row brush tool 209 is selectively slideable between a first position 260 (e.g., a stow position) and a second position 262 (e.g., a use position). When the slideable triple row brush tool 209 is in the first position 260, the slideable triple row brush tool 209 is generally parallel to the longitudinal axis 224 and the slideable triple row brush tool 209 distal end 247 is disposed towards the pick end 218. The slideable triple row brush tool 209 is slideable to a plurality of varying positions lying along the channel 292, each position defined by a distance 275 from the first position 260. The distance 275 is variable depending on how much the slideable triple row brush tool 209 is slid away from the first position 260. More specifically, in one suitable embodiment, the distance 275 ranges from 0 mm when the slideable triple row brush tool 209 is in the first position 260, to between about 22 mm and 50 mm when the slideable triple row brush tool 209 is in the second position 262. It is understood that the slideable triple row brush tool 209 may be slid to any distance in relation to any portions of the dental cleaning tool 200 without departing from some aspects of this disclosure.

It is contemplated that in some suitable embodiments, the slideable toothpick tool 208, the slideable triple row brush tool 209, and/or the slideable brush tool 210 can be completely removable from the dental cleaning tool 200 in the second, use position.

The slideable toothpick tool 208 and the slideable brush tool 210 may extend from any portion of the handle 202. In the illustrated embodiment, the slideable toothpick tool 208 extends in a plane generally parallel to the longitudinal axis 224 along the first side wall 228 of the handle 202. Additionally, in the illustrated embodiment, the slideable brush tool 210 extends in a plane generally parallel to the longitudinal axis 224 along the second side wall 230 of the handle 202. In suitable embodiments, the slideable toothpick tool 208 and the slideable brush tool 210 may be oriented in any manner without departing from some aspects of this disclosure.

In another suitable embodiment, the slideable toothpick tool 208 and the slideable triple row brush tool 209 may extend from any portion of the handle 202. In the other suitable embodiment, the slideable toothpick tool 208 extends in a plane generally parallel to the longitudinal axis 224 along the first side wall 228 of the handle 202. Additionally, in the other suitable embodiment, the slideable triple row brush tool 209 extends in a plane generally parallel to the longitudinal axis 224 along the second side wall 230 of the handle 202. In suitable embodiments, the slideable toothpick tool 208 and the slideable triple row brush tool 209 may be oriented in any manner without departing from some aspects of this disclosure.

Once the slideable toothpick tool 208 is selectively slid to the second position 266 the user can comfortably use the slideable toothpick tool 208 to clean their teeth. In particular, the user can comfortably hold the handle 202 and position the slideable toothpick tool 208 against various surfaces of their teeth without having to awkwardly position their hand in relation to their mouth or awkwardly position the dental cleaning tool 200 within their mouth. Additionally, the slideable toothpick tool 208 facilitates the dental cleaning tool 200 to reach difficult locations in a user's mouth (i.e., the back of the user's mouth). Moreover, the dental cleaning tool 200 is configured such that the slideable toothpick tool 208 can be positioned in a variety of positions without being obstructed by the floss holder 204 and vice-versa.

Additionally, when the slideable brush tool 210 is selectively slid to the second position 262 the user can comfortably use the slideable brush tool 210 to clean their teeth. In particular, the user can comfortably hold the handle 202 and position the slideable brush tool 210 against various surfaces of their teeth without having to awkwardly position their hand in relation to their mouth or awkwardly position the dental cleaning tool 200 within their mouth. Additionally, the slideable brush tool 210 facilitates the dental cleaning tool 200 to reach difficult locations in a user's mouth (i.e., the back of the user's mouth). Moreover, the dental cleaning tool 200 is configured such that the slideable brush tool 210 can be positioned in a variety of positions without being obstructed by the floss holder 204 and vice-versa.

In another suitable embodiment, when the slideable triple row brush tool 209 is selectively slid to the second position 262 the user can comfortably use the slideable triple row brush tool 209 to clean their teeth. In particular, the user can comfortably hold the handle 202 and position the slideable triple row brush tool 209 against various surfaces of their teeth without having to awkwardly position their hand in relation to their mouth or awkwardly position the dental cleaning tool 200 within their mouth. Additionally, the slideable triple row brush tool 209 facilitates the dental cleaning tool 200 to reach difficult locations in a user's mouth (i.e., the back of the user's mouth). Moreover, the dental cleaning tool 200 is configured such that the slideable triple row brush tool 209 can be positioned in a variety of positions without being obstructed by the floss holder 204 and vice-versa.

As best illustrated in FIGS. 57-60, the rod 268 of slideable brush tool 210 has a distal end 280 and a proximal end 281. A length 279 is measured between the distal end 280 and the proximal end 281. Suitably, the length 279 is between about 10 mm and about 20 mm. In the illustrated embodiment, for example, the length 279 is approximately 15 mm. Suitably, the rod 268 is of a cylindrical shape with a sidewall 276 extending from the proximal end 281 to the distal end 280. In the illustrated embodiment, the sidewall 276 is of a non-tapering cylindrical shape that extends from the proximal end 281 to the distal end 280.

With reference to FIGS. 57-60, the slideable brush tool 210 has a proximal end 278 and a distal end 280. A length 272 is measured between the distal end 280 and the proximal end 278. Suitably, the length 272 is between about 27 mm and about 52 mm. In the illustrated embodiment, for example, the length 272 is approximately 40 mm. The slideable brush tool 210 has a width 287. Suitably, the width 287 is between about 2.5 mm and about 5 mm. In the illustrated embodiment, for example, the width 287 is approximately 3.5 mm. Suitably, the slideable brush tool 210 has a base 254 of base length 269 extending from the proximal end 278 to the rod proximal end 281. The slideable brush tool 210 has a pair of retention channels 257 that extend along the longitudinal axis of the tool 210. The retention channels 257 are configured to engage the rails 294, 295, 296, and 297 to facilitate retention of the tool 210 in the first position 260, the second position 262, and throughout the range of motion of the tool 210. The slideable brush tool 210 has a rib 289 of length 293, of width 290, and of height 291 that extends along the longitudinal axis of the tool 210 on the lower side of the base 254. The rib 289 is configured to engage channel 292 to further facilitate retention of the tool 210 in the first position 260, the second position 262, and throughout the range of motion of the tool 210.

In another suitable embodiment, as best illustrated in FIGS. 61-64, the rod 241 of slideable triple row brush tool 209 has a distal end 247 and a proximal end 264. A length 251 is measured between the distal end 247 and the proximal end 264. Suitably, the length 251 is between about 10 mm and about 20 mm. In the illustrated embodiment, for example, the length 251 is approximately 15 mm. Suitably, the rod 241 is of a conical shape with a sidewall 266 extending from the proximal end 264 to the distal end 247. In the illustrated embodiment, the sidewall 266 is of a tapering conical shape that extends from the proximal end 264 to the distal end 247.

With reference to FIGS. 61-64, the slideable triple row brush tool 209 has a base end 299 and a distal end 247. A length 277 is measured between the distal end 247 and the base end 299. Suitably, the length 277 is between about 27 mm and about 52 mm. In the illustrated embodiment, for example, the length 277 is approximately 40 mm. The slideable triple row brush tool 209 has a width 287. Suitably, the width 287 is between about 2.5 mm and about 5 mm. In the illustrated embodiment, for example, the width 287 is approximately 3.5 mm. Suitably, the slideable triple row brush tool 209 has a base 339 of base length 249 extending from the base end 299 to the rod proximal end 264. The slideable triple row brush tool 209 has a pair of retention channels 255 that extend along the longitudinal axis of the tool 210. The retention channels 255 are configured to engage the rails 294, 295, 296, and 297 to facilitate retention of the tool 209 in the first position 260, the second position 262, and throughout the range of motion of the tool 209. The slideable triple row brush tool 209 has a rib 289 of length 293, of width 290, and of height 291 that extends along the longitudinal axis of the tool 209 on the lower side of the base 254. The rib 289 is configured to engage channel 292 to further facilitate retention of the tool 210 in the first position 260, the second position 262, and throughout the range of motion of the tool 209.

As best illustrated in FIGS. 53-56, the slideable toothpick tool 208 has a proximal end 284 and a distal end 286. A length 274 is measured between the distal end 286 and the proximal end 284. Suitably, the length 274 is between about 27 mm and about 52 mm. In the illustrated embodiment, for example, the length 274 is approximately 40 mm. The slideable toothpick tool 208 has a width 287. Suitably, the width 287 is between about 2.5 mm and about 5 mm. In the illustrated embodiment, for example, the width 287 is approximately 3.5 mm. Suitably, the slideable toothpick tool 208 has a base 258 of length 275 extending from the proximal end 284 and a sidewall extending from the base 258 to the pointed tip 256 at the distal end 286 having a pick length 283. In the illustrated embodiment, the sidewall 282 tapers as it extends from the base 258 to the pointed tip 256 at the distal end 286. The pointed tip 256 at the distal end 286 facilitates the distal end 286 being positioned in tight spaces for cleaning purposes. The slideable toothpick tool 208 has a pair of retention channels 257 that extend along the longitudinal axis of the tool 208. The retention channels 257 are configured to engage the rails 294, 295, 296, and 297 to facilitate retention of the tool 208 in the first position 260, the second position 262, and throughout the range of motion of the tool 208. The slideable toothpick tool 208 has a rib 289 of length 293, of width 290, and of height 291 that extends along the longitudinal axis of the tool 208 on the lower side of the base 254. The rib 289 is configured to engage channel 292 to further facilitate retention of the tool 208 in the first position 260, the second position 262, and throughout the range of motion of the tool 208.

As best illustrated in FIG. 57-60, the bristles 271 extend from the rod 268 for cleaning the user's teeth. The bristles 271 may be arranged in any suitable manner. In the illustrated embodiment, the bristles 271 are arranged in a plurality of bristle groups 270 spaced along the length of the rod 268 and spaced annularly around the circumference of the rod 268. In other suitable embodiments, the bristles 271 may be continuous along the length and/or circumference of the rod 268 instead of being arranged in the spaced bristle groups 270. Additionally, in suitable embodiments, the bristles 271 may extend from only a portion of the rod 268, e.g., along only side of the rod 268 or only at the distal end 280. In the illustrated embodiment, the bristle groups 270 are arranged in rows extending along the length 279 of the rod 268 that are spaced annularly around the circumference of the rod 268. It is understood that the bristles 271 can be grouped in any suitable manner or can be arranged randomly on the rod 268.

In another suitable embodiment, as best illustrated in FIG. 61-64, the bristles 245 extend from the rod 241 for cleaning the user's teeth. The bristles 245 may be arranged in any suitable manner. In the illustrated embodiment, the bristles 245 are arranged in a series of three rows 237 spaced equidistant from each other around the circumference of the rod 241 and spaced annularly around the length of the rod 241. In other suitable embodiments, the bristles 245 may be continuous along the length and/or circumference of the rod 241 instead of being arranged in the spaced bristle rows 237. Additionally, in suitable embodiments, the bristles 245 may extend from only a portion of the rod 241, e.g., along only side of the rod 241 or only at the distal end 247. In other suitable embodiments, the bristles 133 may be integrally formed with the rod 113. In the illustrated embodiment, the bristle rows 237 are arranged in 3 rows extending along the length 251 of the rod 241 that are spaced annularly around the perimeter of the rod 241. It is understood that the bristles 245 can be grouped in any suitable manner or can be arranged randomly on the rod 241.

In suitable embodiments, the dental cleaning tool 200 may be formed in any suitable manner and of any suitable material. For example, the dental cleaning tool 200 may be formed from metal, wood, plastic, and/or combinations thereof. In one preferred embodiment, at least the handle 202, the floss holder 204, and the toothpick 206 of the dental cleaning tool 200 are molded or otherwise formed from a single piece of resilient synthetic material, such as, but not limited to, plastic or metal. In the illustrated embodiment, the handle 202, the floss holder 204, and the toothpick 206 are integrally formed. More specifically in the illustrated embodiment, the dental cleaning tool 200, except for the floss strands 248, the slideable toothpick tool 208, the slideable brush tool 210, and in other suitable embodiments, the slideable triple row brush tool 209, is molded as a single piece from acceptable food grade plastic. In other embodiments, any of the handle 202, the floss holder 204, the toothpick 206, the slideable toothpick tool 208, the slideable brush tool 210, and the slideable triple row brush tool 209 may be separately formed and attached to the dental cleaning tool 200 during assembly.

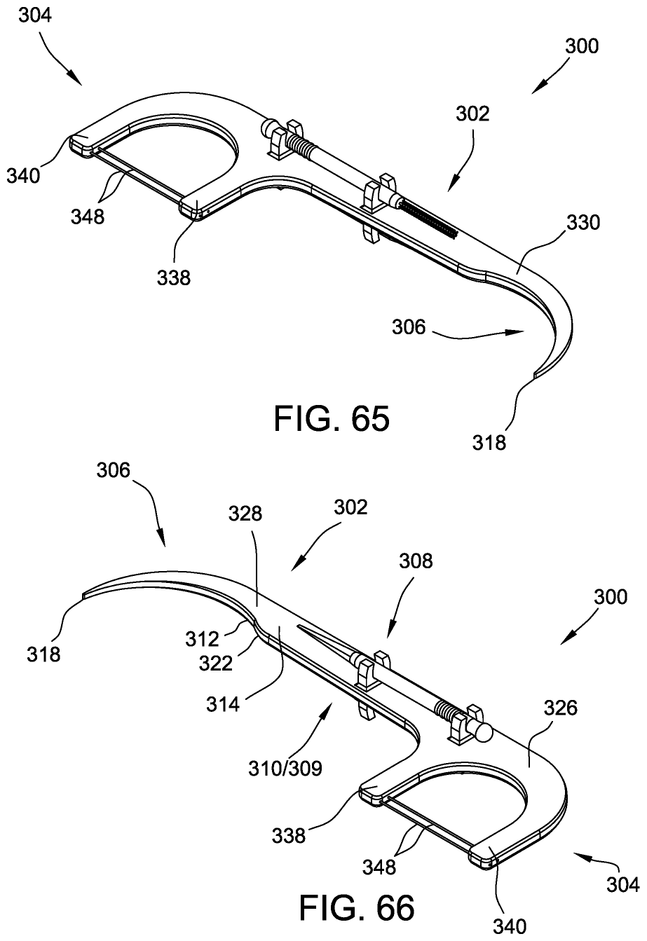

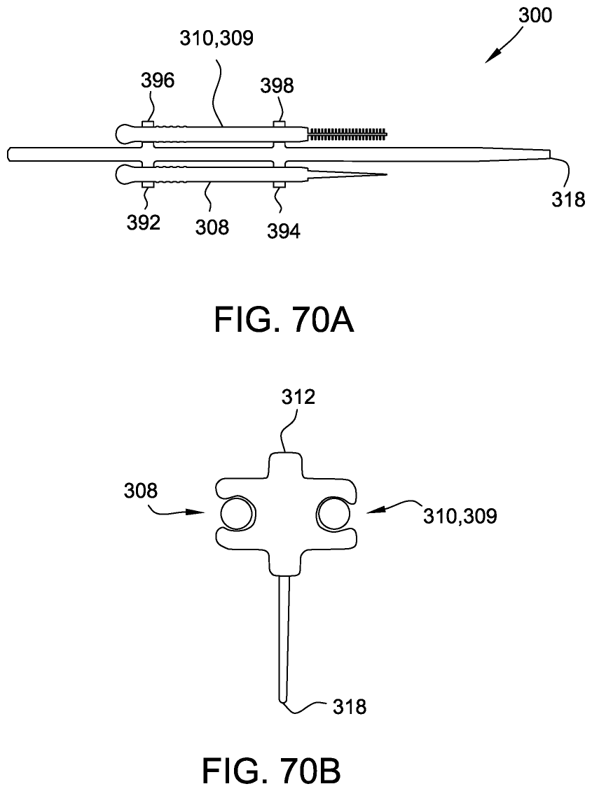

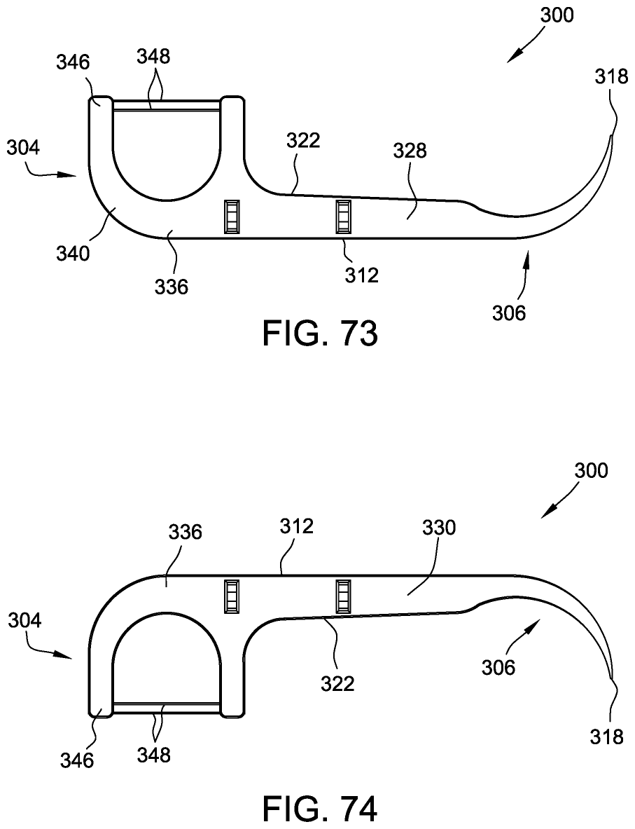

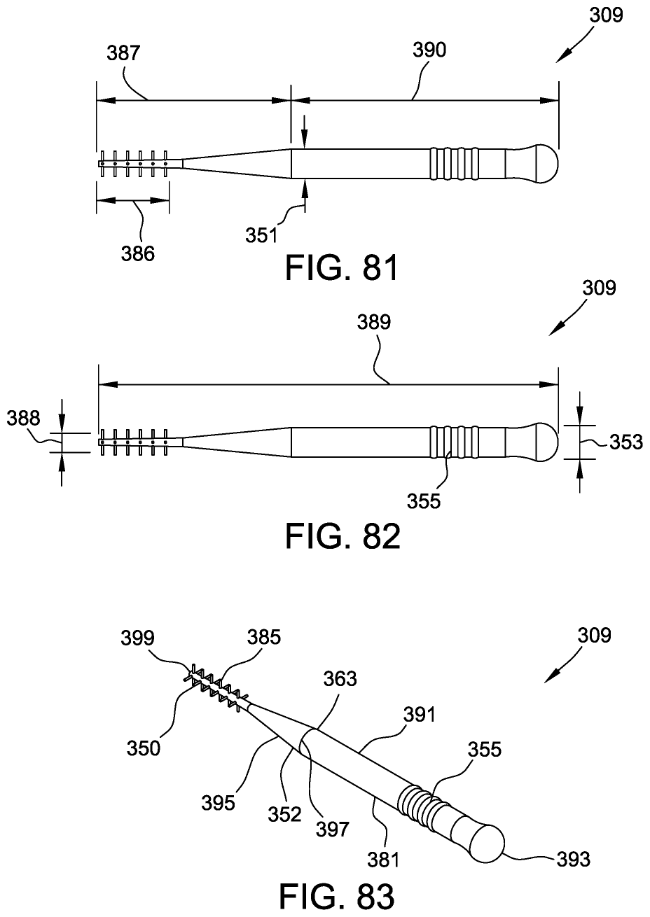

FIGS. 65-80 illustrate another suitable embodiment of a dental cleaning tool, indicated generally at 300. As seen therein, the illustrated dental cleaning tool 300 includes a handle 302, a floss holder 304, an integrally formed toothpick 306, a detachable toothpick tool 308, and a detachable brush tool 310. A detachable triple row brush tool 309 suitable for use with the dental cleaning tool 300 is illustrated in FIGS. 81-83. The handle 302, the floss holder 304, the integrally formed toothpick 306, the detachable toothpick tool 308, the detachable brush tool 310, and the detachable triple row brush tool 309 are each indicated generally by their respective reference number in the accompanying FIGS. 65-83. It is understood that in some other suitable embodiments that do not depart from some of the aspects of this disclosure, the dental cleaning tool 300 may include any combination(s) of the floss holder 304, the toothpick 306, the detachable toothpick tool 308, the detachable brush tool 310, and the detachable triple row brush tool 309. It is contemplated that in some suitable embodiments the dental cleaning tool 300 can include only one of the detachable toothpick tool 308, the detachable brush tool 310, and the detachable triple row brush tool 309.

As illustrated in FIGS. 65-74, the handle 302 includes a grip portion 314, a floss end 316, and a pick end 318. In the illustrated embodiment, the handle 302 has a length 320 measured between the floss end 316 and the pick end 318 along a longitudinal axis 324 of the dental cleaning tool 300, which extends through the handle 302. In suitable embodiments, the length 320 of the handle 302 may be any measurement that enables the dental cleaning tool 300 to function as described herein. Suitably, the length 320 is in the range between about 43 mm and about 52 mm. In the illustrated embodiment, for example, the length 320 of the handle 302 is approximately 48 mm.

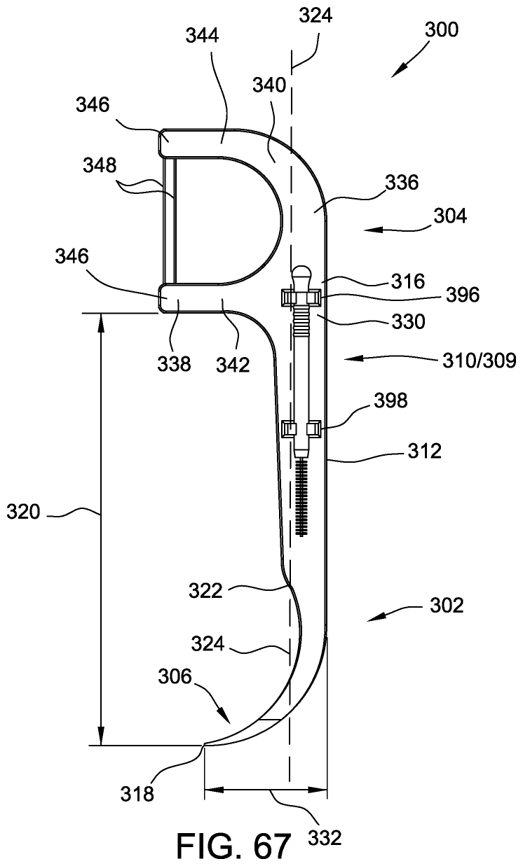

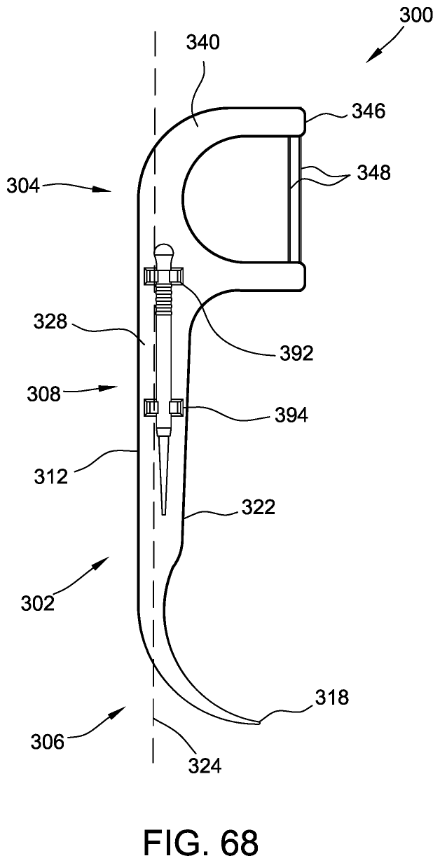

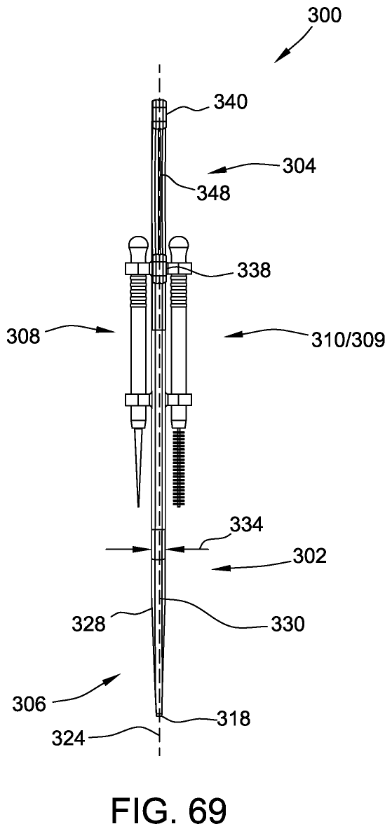

In the illustrated embodiment and as best seen in FIGS. 65-74, the handle 302 includes a front wall 322, an opposing rear wall 326, a first side wall 328, and a second side wall 330 opposite the first side wall. As illustrated in FIGS. 67-69, the side walls 328, 330 are oriented perpendicularly to and connect the front and rear walls 322, 326. A width 332 (FIGS. 67 and 68) is measured between the front wall 322 and the rear wall 326 and a thickness 334 (FIG. 69) is measured between the two side walls 328, 330. Suitably, the width 332 of the handle 302 is in the range between about 3.8 mm and about 5.8 mm. In the illustrated embodiment, for example, the width 332 is approximately 4.8 mm. Suitably, the thickness 334 of the handle 302 is in the range between about 1.5 mm and about 2.8 mm. In the illustrated embodiment, for example, the thickness 334 is approximately 1.9 mm.

The toothpick 306, which defines a distal end portion of the handle 302 and, more specifically, defines the pick end 318 of the handle, facilitates removing and/or loosening debris such as food remnants from between the user's teeth. It is contemplated that the toothpick 306 can have any suitable shape that facilitates the removal of debris between adjacent teeth. In the illustrated embodiment, the pick end 318 of the handle 302 is pointed to define the toothpick 306. Specifically, the width of at least of the first side wall 328 and the second side wall 330 tapers to a point towards the pick end 318. In the illustrated embodiment, as best seen in FIG. 69, both the first side wall 328 and the second side wall 330 taper towards the pick end 318. As a result, the front wall 322 and the rear wall 326 meet at the pick end 318. It is understood that only one of the first side wall 328 and the second side wall 330 could taper. For example, in one other suitable embodiment, only the second side wall 330 could taper and, in such an embodiment, the first side wall 328 would be generally planar.

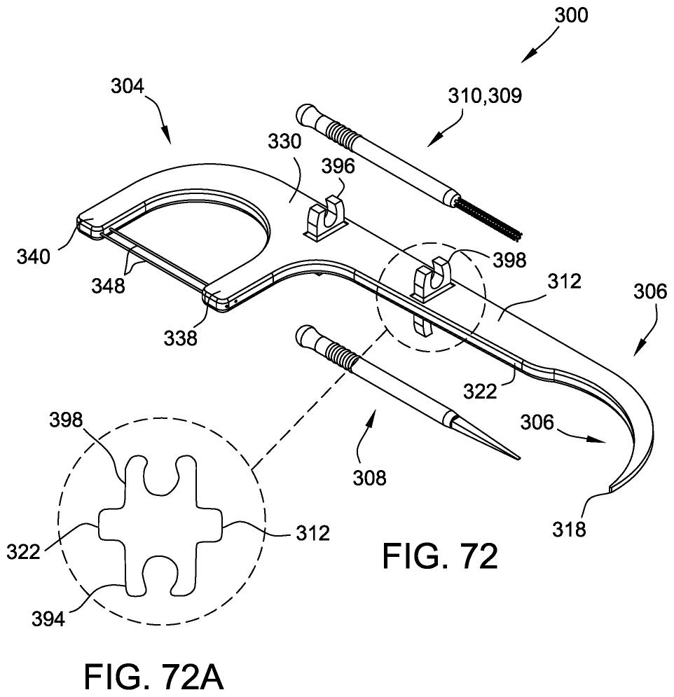

In the illustrated embodiment, as best seen in FIGS. 65-74, attachment points 392, 394, 396, and 398 are sized and configured to receive and detachably retain one of their respective side's detachable tools 308, 310. More specifically, the first side attachment point 392 is disposed on the first side 328 towards the floss holder 304 of the tool 300. The first side attachment point 394 is disposed on the first side 328 towards the toothpick 306 of the tool 300. The second side attachment point 396 is disposed on the second side 330 towards the floss holder 304 of the tool 300. The second side attachment point 398 is disposed on the second side 330 towards the toothpick 306 of the tool 300. As seen in FIG. 72, the attachment points 392, 394, 396, and 398 have a substantially circular inner profile to facilitate substantially interfacing with the base diameter of the detachable tools 308 and 310. However, it is understood that in other suitable embodiments, the attachment points 392, 394, 396, and 398 may have any suitable inner and outer shape to facilitate accepting and detachably retaining the detachable tools 308 and 310. Additionally, as seen in FIGS. 65-74, there are two attachment points per side on the tool 300. Further, it is understood that any suitable number of attachment points per side may be utilized in order to facilitate detachably retaining the detachable tools 308, and 310.

In another suitable embodiment, as best seen in FIGS. 65-74, attachment points 392, 394, 396, and 398 are sized and configured to receive and detachably retain one of the detachable tools 308, and 309. More specifically, the first side attachment point 392 is disposed on the first side 328 towards the floss holder 304 of the tool 300. The first side attachment point 394 is disposed on the first side 328 towards the toothpick 306 of the tool 300. The second side attachment point 396 is disposed on the second side 330 towards the floss holder 304 of the tool 300. The second side attachment point 398 is disposed on the second side 330 towards the toothpick 306 of the tool 300. As seen in FIG. 72, the attachment points 392, 394, 396, and 398 have a substantially circular inner profile to facilitate substantially interfacing with the bases 358, 391 of the detachable tools 308 and 309. However, it is understood that in other suitable embodiments, the attachment points 392, 394, 396, and 398 may have any suitable inner and outer shape to facilitate accepting and detachably retaining the detachable tools 308, and 309. Additionally, as seen in FIG. 65-74, there are two attachment points per side on the tool 300. Further, it is understood that any suitable number of attachment points per side may be utilized in order to facilitate detachably retaining the detachable tools 308 and 309.

In the illustrated embodiment, the toothpick 306 is formed as a single piece with the handle 302. In other words, the toothpick 306 is an integral extension of the handle 302. It is understood, however, that the toothpick 306 can be formed as a separate component and attached to the handle 302 during assembly of the dental cleaning tool 300. It is also contemplated that the toothpick 306 can be removably attached to the dental cleaning tool 300 in other suitable embodiments without departing from some aspects of this disclosure.

In the illustrated embodiment, the floss holder 304 extends from the floss end 316 of the handle 302. The floss holder 304 includes an arcuate (or broadly, nonlinear) base 336 and two arms (an inner arm 338 and an outer arm 340) extending in spaced relationship from each other from the base. As seen in FIG. 67-68, the inner arm 338 and the outer arm 340 are substantially parallel relative to each other. The floss holder 304 in the illustrated embodiment is generally U-shaped. However, it is understood that in other suitable embodiments, the floss holder 304 may have any suitable shape.

In the illustrated embodiment, the floss holder 304 is formed as a single-piece with the handle 302. In other words, the floss holder 304 is an integral extension of the handle 302. It is understood, however, that the floss holder 304 can be formed as a separate component and attached to the handle 302 during assembly of the dental cleaning tool 300.

With reference still to FIG. 65-80, the dental cleaning tool 300 includes a curved portion 342 extending between the handle 302 and the floss holder 304. As a result, in the illustrated embodiment, a majority of the base 336 of the floss holder 304 is disposed below the longitudinal axis 324 of the dental cleaning tool 300. The curved portion 342 facilitates the user gripping the handle 302 and positioning the floss holder 304 in the user's mouth. It is understood that the floss holder 304 can be oriented in any manner in relation to the handle 302 that enables the floss holder 304 to function as described herein. For example, the curved portion 342 can be omitted in some suitable embodiments. In such embodiments, the base 336 of the floss holder 304 would be aligned with the longitudinal axis 324 of the dental cleaning tool 300. Further, in the illustrated embodiment, a ridge 312 extends about the perimeter of the dental cleaning tool 300 to provide additional strength to the dental cleaning tool 300 and facilitate a user gripping the dental cleaning tool 300.

Each of the inner arm 338 and the outer arm 340, which are cantilevered with respect to base 336, includes a proximal portion 344 and a distal portion 346. The proximal portions 344 are connected to the base 336 and the distal portions 346 are spaced from the base 336. At least one floss strand 348 extends between the distal portions 346 of the inner and outer arms 338, 340. For example, in the illustrated embodiment, two floss strands 348 extend between the inner arm 338 and the outer arm 340. Suitably, the floss strands 348 are substantially parallel to each other. It is understood that the floss holder 304 may have any suitable configuration without departing from some aspects of this disclosure. For example, the floss strands 348 may be selectively removable from the inner arm 338 and the outer arm 340 such that the user can manually remove and/or replace the floss strands 348.

In one suitable embodiment, the detachable toothpick tool 308 and the detachable brush tool 310 are detachably mounted to the handle 302 of the dental cleaning tool 300. Suitably, when mounted to the handle 302, the detachable toothpick tool 308 and the detachable brush tool 310 extend in planes substantially parallel to the longitudinal axis 324, each along one of the first side wall 328 and the second side wall 330. In the illustrated embodiment, when mounted to the handle 302, the detachable toothpick tool 308 is held within the second side attachment points 398 and 396, and extends along the second side wall 330. The detachable brush tool 310 is held within the first side attachment points 392 and 394, and extends along the first side wall 328. It is understood, however, that the detachable toothpick tool 308 and the detachable brush tool 310, when mounted to the dental tool 300, may extend along any portion of the dental cleaning tool 300 in other suitable embodiments without departing from some aspects of this disclosure.

In another suitable embodiment, the detachable triple row brush tool 309 and one of the detachable toothpick tool 308 and the detachable toothpick tool 308 are detachably mounted to the handle 302 of the dental cleaning tool 300. Suitably, when mounted to the handle 302, the detachable toothpick tool 308, the detachable triple row brush tool 309, and detachable toothpick tool 308 extend in planes substantially parallel to the longitudinal axis 324, each along one of the first side wall 328 and the second side wall 330. In the illustrated embodiment, when mounted to the handle 302, the detachable toothpick tool 308 is held within the second side attachment points 398 and 396, and extends along the second side wall 330. The detachable triple row brush tool 309 is held within the first side attachment points 392 and 394, and extends along the first side wall 328. It is understood, however, that the detachable triple row brush tool 309, the detachable toothpick tool 308 and the detachable triple row brush tool 309, when mounted to the dental tool 300, may extend along any portion of the dental cleaning tool 300 in other suitable embodiments without departing from some aspects of this disclosure.

With reference to FIGS. 65-77, the detachable toothpick tool 308 includes a pointed tip 356, base portion 358, and a checkered area 355. More generally, the detachable toothpick tool 308 is detachably mounted to and extends along the handle 302. More specifically, the detachable toothpick tool 308 is detachably mounted to and extends along the second side wall 330. In the illustrated embodiment, the detachable toothpick tool 308 extends beyond the transverse extent of the floss holder 304. That is, the detachable toothpick tool 308 extends transversely along the longitudinal axis 324 a greater distance than the base 336 of the floss holder 304. As seen in FIG. 69, the illustrated detachable toothpick tool 308 is disposed, in its entirety, along the second side wall 330.

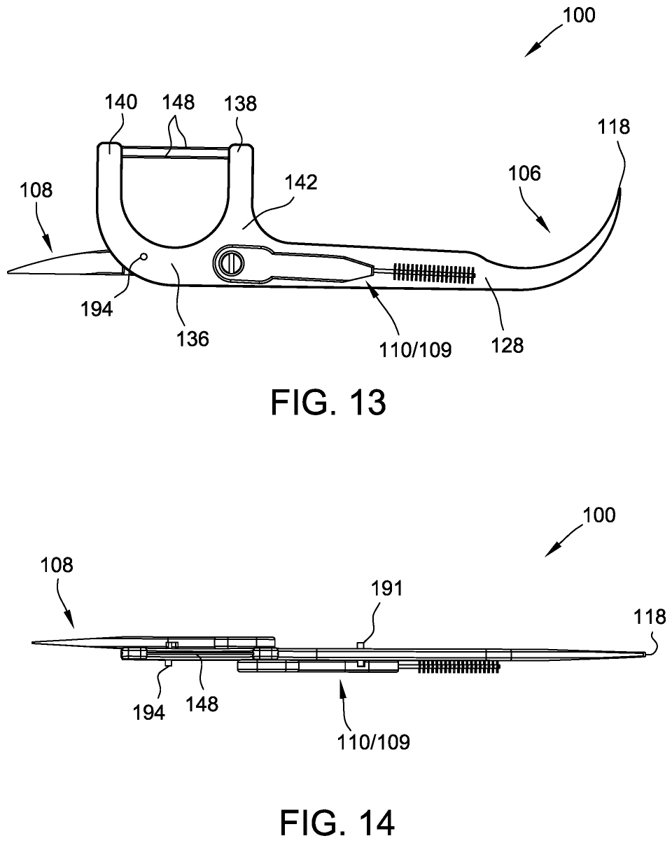

With reference to FIGS. 65-74 and 78-80, the detachable brush tool 310 includes a rod 368, a plurality of bristles 367 extending from the rod 368, a base 354, and a checkered area 355. More generally, the detachable brush tool 310 is detachably mounted to and extends along the handle 302. More specifically, the detachable brush tool 310 is detachably mounted to and extends along the first side wall 328. In the illustrated embodiment, the detachable brush 310 extends beyond the transverse extent of the floss holder 304. That is, the detachable brush 310 extends transversely along the longitudinal axis 324 a greater distance than the base 336 of the floss holder 304. As in in FIG. 13, the illustrated detachable brush tool 310 is disposed, in its entirety, along the first side wall 328.

In another suitable embodiment, with reference to FIGS. 65-74 and 81-83, the detachable brush tool 309 includes a rod 395, a plurality of bristles 385 extending from the rod 395, a base 391, and a checkered area 355. More generally, the detachable triple row brush tool 309 is detachably mounted to and extends along the handle 302. More specifically, the detachable triple row brush tool 309 is detachably mounted to and extends along the first side wall 328. In the illustrated embodiment, the detachable triple row brush tool 309 extends beyond the transverse extent of the floss holder 304. That is, the detachable triple row brush tool 309 extends transversely along the longitudinal axis 324 a greater distance than the base 336 of the floss holder 304. As in in FIG. 69, the illustrated detachable triple row brush tool 309 is disposed, in its entirety, along the first side wall 328.

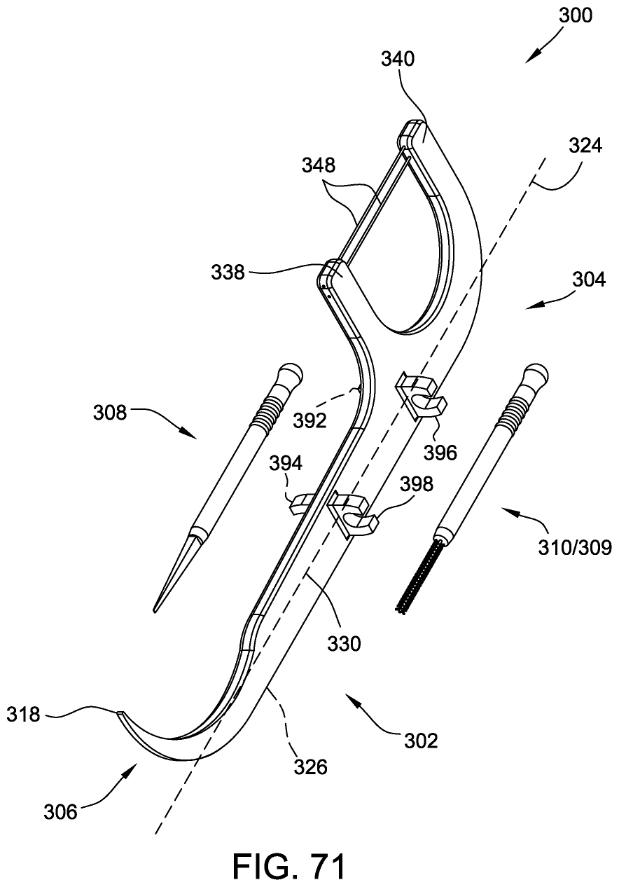

The detachable toothpick tool 308 is selectively detachable between a first position 360 (e.g., a stow position) and a second position 362 (e.g., a use position). As shown in FIGS. 65-70, when the detachable toothpick tool 308 is in the first position 364, the detachable toothpick tool 308 is generally parallel to the longitudinal axis 324 and the detachable toothpick tool pointed tip 356 is disposed towards the pick end 318. As illustrated in FIGS. 71 and 72, the detachable toothpick tool 308 is detachable to a plurality of second positions 362. Moreover, it is understood that the detachable toothpick tool 308 may be angled in relation to any portions of the dental cleaning tool 300 when in the first position 360 without departing from some aspects of this disclosure.

The detachable brush tool 310 is selectively detachable between a first position 360 (e.g., a stow position) and a second position 362 (e.g., a use position). As shown in FIGS. 65-70, when the detachable brush tool 310 is in the first position 360, the detachable brush tool 310 is generally parallel to the longitudinal axis 324 and the detachable brush tool distal end 380 is disposed towards the pick end 318. As illustrated in FIGS. 71 and 72, the detachable brush tool 310 is detachable to a plurality of second positions 362. Moreover, it is understood that the detachable brush tool 310 may be angled in relation to any portions of the dental cleaning tool 300 when in the first position 360 without departing from some aspects of this disclosure.

The detachable triple row brush tool 309 is selectively detachable between a first position 360 (e.g., a stow position) and a second position 362 (e.g., a use position). As shown in FIG. 65-70, when the detachable triple row brush tool 309 is in the first position 360, the detachable triple row brush tool 309 is generally parallel to the longitudinal axis 324 and the detachable brush tool distal end 399 is disposed towards the pick end 318. As illustrated in FIGS. 71 and 72, the detachable triple row brush tool 309 is detachable to a plurality of second positions 362. Moreover, it is understood that the detachable triple row brush tool 309 may be angled in relation to any portions of the dental cleaning tool 300 when in the first position 360 without departing from some aspects of this disclosure.

When mounted to the dental tool 300, the detachable toothpick tool 308 and the detachable brush tool 310 may extend from any portion of the handle 302. In the illustrated embodiment, the detachable brush tool 310 extends in a plane generally parallel to the longitudinal axis 324 along the first side wall 328 of the handle 302. Additionally, in the illustrated embodiment, when mounted to the dental tool 300, the detachable toothpick tool 308 extends in a plane generally parallel to the longitudinal axis 324 along the second side wall 330 of the handle 302. In suitable embodiments, when mounted to the dental tool 300, the detachable toothpick tool 308 and the detachable brush tool 310 may be oriented in any manner without departing from some aspects of this disclosure.

In another suitable embodiment, when mounted to the dental tool 300, the detachable toothpick tool 308 and the detachable triple row brush tool 309 may extend from any portion of the handle 302. In the illustrated embodiment, the detachable triple row brush tool 309 extends in a plane generally parallel to the longitudinal axis 324 along the first side wall 328 of the handle 302. Additionally, in the illustrated embodiment, when mounted to the dental tool 300, the detachable toothpick tool 308 extends in a plane generally parallel to the longitudinal axis 324 along the second side wall 330 of the handle 302. In suitable embodiments, when mounted to the dental tool 300, the detachable toothpick tool 308 and the detachable triple row brush tool 309 may be oriented in any manner without departing from some aspects of this disclosure.

Once the detachable toothpick tool 308 is selectively detached to the second position 362, the user can comfortably use the detachable toothpick tool 308 to clean their teeth. In particular, the user can comfortably hold the base 358 of the detachable toothpick 308 and position the detachable toothpick tool 308 against various surfaces of their teeth without having to awkwardly position their hand in relation to their mouth or awkwardly position the dental cleaning tool 300 within their mouth. Additionally, the detachable toothpick tool 308 enables the detachable toothpick tool 308 to be detached from the dental cleaning tool 300 to reach difficult locations in a user's mouth (i.e., the back of the user's mouth). Moreover, the dental cleaning tool 300 is configured such that the detachable toothpick tool 308 can be detached and then be positioned in a variety of positions without being obstructed by any other part of the dental cleaning tool 300 and vice-versa.

Additionally, when the detachable brush tool 310 is selectively detached to the second position 362, the user can comfortably use the detachable brush tool 310 to clean their teeth. In particular, the user can comfortably hold the base 354 of the detachable brush 310 and position the detachable brush tool 310 against various surfaces of their teeth without having to awkwardly position their hand in relation to their mouth or awkwardly position the dental cleaning tool 300 within their mouth. Additionally, the detachable brush tool 310 enables the detachable brush tool 310 to be detached from the dental cleaning tool 300 to reach difficult locations in a user's mouth (i.e., the back of the user's mouth). Moreover, the dental cleaning tool 300 is configured such that the detachable brush tool 310 can be detached and then be positioned in a variety of positions without being obstructed by any other part of the dental cleaning tool 300 and vice-versa.

In another suitable embodiment, when the detachable triple row brush tool 309 is selectively detached to the second position 362, the user can comfortably use the detachable triple row brush tool 309 to clean their teeth. In particular, the user can comfortably hold the base 391 of the detachable brush 309 and position the detachable triple row brush tool 309 against various surfaces of their teeth without having to awkwardly position their hand in relation to their mouth or awkwardly position the dental cleaning tool 300 within their mouth. Additionally, the detachable triple row brush tool 309 enables the detachable triple row brush tool 309 to be detached from the dental cleaning tool 300 to reach difficult locations in a user's mouth (i.e., the back of the user's mouth). Moreover, the dental cleaning tool 300 is configured such that the detachable triple row brush tool 309 can be detached and then be positioned in a variety of positions without being obstructed by any other part of the dental cleaning tool 300 and vice-versa.

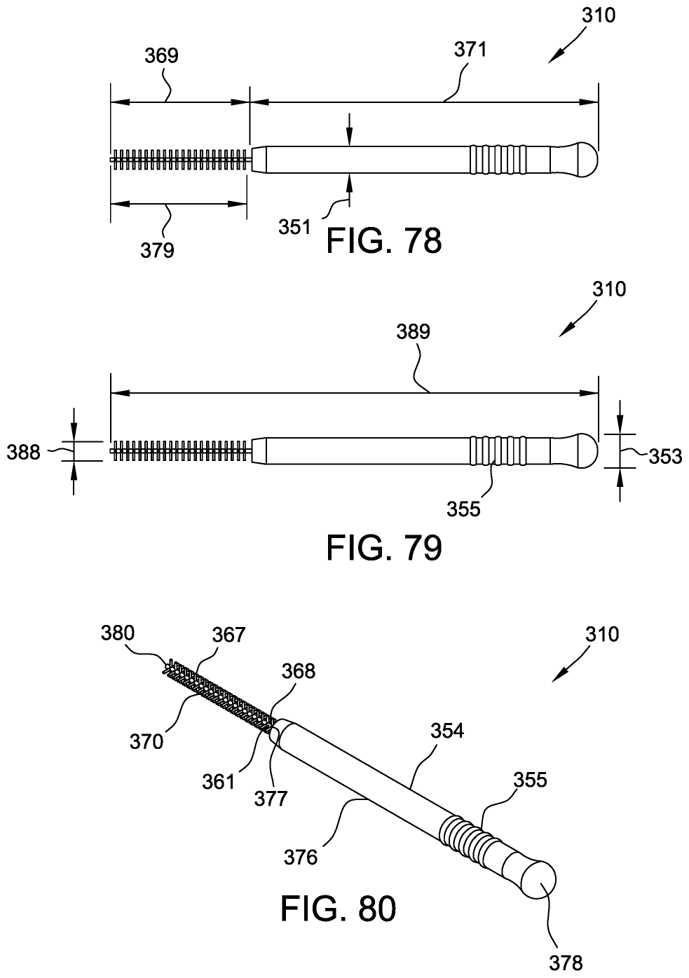

As best illustrated in FIGS. 78-80, the detachable brush tool 310 has a proximal end 378 and a distal end 380. A length 372 is measured between the distal end 380 and the proximal end 378. Suitably, the length 372 is between about 27 mm and about 55 mm. In the illustrated embodiment, for example, the length 372 is approximately 40 mm. In the illustrated embodiment, the tool 310 has a diameter 351. Suitably, the detachable brush tool 310 has a base 354 of base length 371 extending from the proximal end 378 and a sidewall 376 extending from the proximal end 378 to the rod proximal end 377. The base 354 tapers to a substantially spherical region at proximal end 378 having a bulb diameter of 353. The rod 368 of detachable brush tool 310 has a distal end 380 and a proximal end 377. A length 369 is measured between the distal end 380 and the proximal end 377. Suitably, the length 369 is between about 10 mm and about 20 mm. In the illustrated embodiment, for example, the length 369 is approximately 15 mm. Suitably, the rod 368 is of a cylindrical shape with a sidewall 361 extending from the proximal end 377 to the distal end 380. In the illustrated embodiment, the sidewall 376 is of a non-tapering cylindrical shape that extends from the proximal end 377 to the distal end 380. In the illustrated embodiment, the base 358 has a checkered area 355 extending along the sidewall 382 of the base 358.

The bristles 367 extend from the rod 368 for cleaning the user's teeth. The bristles 367 may be arranged in any suitable manner. In the illustrated embodiment, the bristles 367 are arranged in a plurality of bristle groups 370 spaced along the length of the rod 368 and spaced annularly around the circumference of the rod 368. In other suitable embodiments, the bristles 367 may be continuous along the length and/or circumference of the rod 368 instead of being arranged in the spaced bristle groups 370. Additionally, in suitable embodiments, the bristles 367 may extend from only a portion of the rod 368, e.g., along only side of the rod 368 or only at the distal end 380. In the illustrated embodiment, the bristle groups 370 are arranged in rows extending along the length 369 of the rod 368 that are spaced annularly around the circumference of the rod 368. It is understood that the bristles 367 can be grouped in any suitable manner or can be arranged randomly on the rod 368.

In another suitable embodiment, as best illustrated in FIGS. 81-83, the detachable triple row brush tool 309 has a proximal end 393 and a distal end 399. A length 389 is measured between the distal end 399 and the proximal end 393. Suitably, the length 389 is between about 27 mm and about 55 mm. In the illustrated embodiment, for example, the length 389 is approximately 40 mm. In the illustrated embodiment, the tool 309 has a diameter 351. Suitably, the detachable triple row brush tool 309 has a base 391 of base length 390 extending from the proximal end 393 and a sidewall 381 extending from the proximal end 393 to the rod proximal end 363. The base 391 tapers to a substantially spherical region at proximal end 393 having a bulb diameter of 353. The rod 395 of detachable triple row brush tool 309 has a distal end 399 and a proximal end 363. A length 387 is measured between the distal end 399 and the proximal end 363. Suitably, the length 387 is between about 10 mm and about 20 mm. In the illustrated embodiment, for example, the length 387 is approximately 15 mm. Suitably, the rod 395 is of a conical shape with a sidewall 352 extending from the proximal end 363 to the distal end 399. In the illustrated embodiment, the sidewall 352 is of a tapering cylindrical shape that extends from the proximal end 363 to the distal end 399. In the illustrated embodiment, the base 358 has a checkered area 355 extending along the sidewall 382 of the base 358.

The bristles 385 extend from the rod 395 for cleaning the user's teeth. The bristles 385 may be arranged in any suitable manner. In the illustrated embodiment, the bristles 385 are arranged in a plurality of rows 350 spaced along the length of the rod 395 and spaced annularly around the sidewall 352 of the rod 395. In other suitable embodiments, the bristles 385 may be continuous along the length and/or sidewall 352 of the rod 395 instead of being arranged in the rows 350. Additionally, in suitable embodiments, the bristles 385 may extend from only a portion of the rod 395, e.g., along only side of the rod 395 or only at the distal end 399. In other suitable embodiments, the bristles 133 may be integrally formed with the rod 113. In the illustrated embodiment, the rows 350 are arranged in 3 rows extending along the length 387 of the rod 395 that are spaced annularly around the sidewall 352 of the rod 395. It is understood that the bristles 385 can be grouped in any suitable manner or can be arranged randomly on the rod 395.

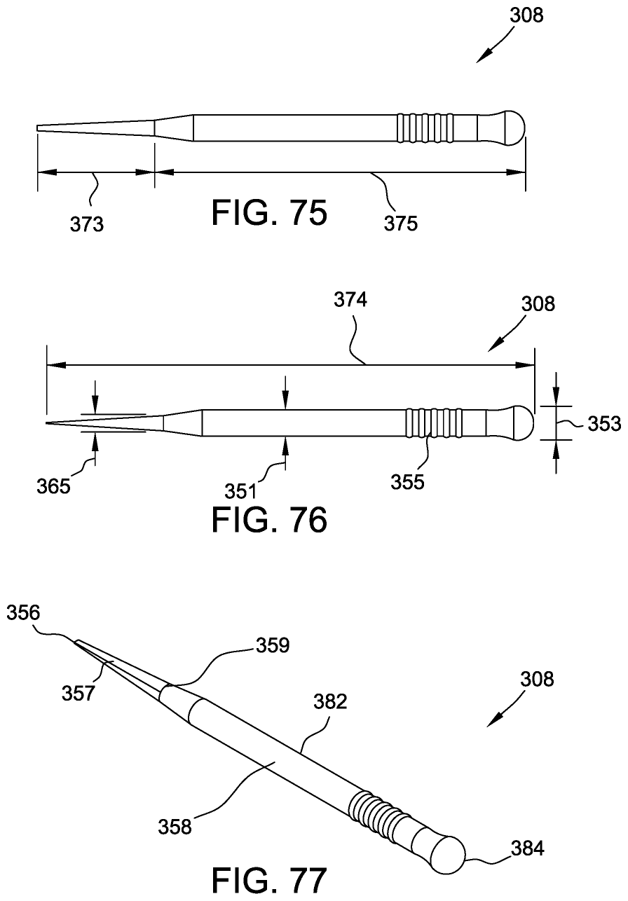

As best illustrated in FIGS. 75-77, the detachable toothpick tool 308 has a proximal end 384 and a distal end 386. A length 374 is measured between the distal end 386 and the proximal end 384. Suitably, the length 374 is between about 27 mm and about 55 mm. In the illustrated embodiment, for example, the length 374 is approximately 40 mm. Suitably, the detachable toothpick tool 308 has a base 358 of base length 375 extending from the proximal end 384 and a sidewall extending from the base 358 to the base distal end 359. The pick 357 extends from the base distal end 359 to the pointed tip 356 at the distal end 386 and has a pick length 373. In the illustrated embodiment, the sidewall 382 tapers as it extends from the base 358 to the pointed tip 356 at the distal end 386. The base 358 tapers to a substantially spherical region at proximal end 384 having a bulb diameter of 353. The pointed tip 356 at the distal end 386 facilitates the distal end 386 being positioned in tight spaces for cleaning purposes. In the illustrated embodiment, the base 358 has a checkered area 355 extending along the sidewall 382 of the base 358.

In suitable embodiments, the dental cleaning tool 300 may be formed in any suitable manner and of any suitable material. For example, the dental cleaning tool 300 may be formed from metal, wood, plastic, and/or combinations thereof. In one preferred embodiment, at least the handle 302, the floss holder 304, and the toothpick 306 of the dental cleaning tool 300 are molded or otherwise formed from a single piece of resilient synthetic material, such as, but not limited to, plastic or metal. In the illustrated embodiment, the handle 302, the floss holder 304, and the toothpick 306 are integrally formed. More specifically in the illustrated embodiment, the dental cleaning tool 300, except for the floss strands 348, the detachable toothpick tool 308, the detachable brush tool 310, and, in other suitable embodiments, the detachable triple row brush tool 309 is molded as a single piece from acceptable food grade plastic. In other embodiments, any of the handle 302, the floss holder 304, the toothpick 306, the detachable toothpick tool 308, the detachable brush tool 310, and the detachable triple row brush tool 309 may be separately formed and attached to the dental cleaning tool 300 during assembly.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the disclosure, it is intended that all matter contained in the above description and shown in the accompanying drawings shall be interpreted as illustrative and not in a limiting sense.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A dental cleaning tool comprising:
a handle defining a longitudinal axis of the tool, the handle comprising:
a floss holder having a base and two arms extending from the base in perpendicular relation to the longitudinal axis;
at least one strand of floss extending between the two arms;
a toothpick being formed as one piece with the handle and having a pointed tip, the toothpick being spaced from the floss holder such that the handle is disposed between the toothpick and the floss holder; and
at least one rotatable dental tool formed separately from and attached to the handle, the at least one rotatable dental tool being rotatably mounted to the handle between a first, stow position and a second, use position.

2. The dental cleaning tool in accordance with claim 1, wherein the at least one rotatable dental tool comprises:
a rotatable brush tool attached to the handle, the rotatable brush tool comprising a base portion and a rod portion, bristles being disposed on the rod; and
a rotatable toothpick tool attached to the handle, the rotatable toothpick tool comprising a base portion and a pointed tip.

3. The dental cleaning tool in accordance with claim 2, wherein the rotatable brush tool and the rotatable toothpick tool are disposed on opposing sides of the handle.

4. The dental cleaning tool in accordance with claim 1, further comprising a nub and catch system that secures the at least one rotatable dental tool in the first, stow position and the second, use position.

5. The dental cleaning tool in accordance with claim 1, wherein the at least one rotatable dental tool is mounted to the handle with a snap-fit relationship between the base portion of the at least one rotatable dental tool and the handle.

6. The dental cleaning tool in accordance with claim 1, wherein the floss holder, handle, and toothpick are formed as a single piece.

7. A dental cleaning tool comprising:
a handle defining a longitudinal axis of the tool, the handle comprising:
a floss holder having a base and two arms extending from the base in perpendicular relation to the longitudinal axis;
at least one strand of floss extending between the two arms;
a toothpick being formed as one piece with the handle and having a pointed tip, the toothpick being spaced from the floss holder such that the handle is disposed between the toothpick and the floss holder; and
at least one slideable dental tool formed separately from and attached to the handle, the at least one slideable dental tool being slidably mounted to the handle between a first, stow position and a second, use position.

8. The dental cleaning tool in accordance with claim 7, wherein the at least one slideable dental tool comprises:
a slideable brush tool attached to the handle, the slideable brush tool comprising a base portion and a rod portion, bristles being disposed on the rod; and
a slideable toothpick tool attached to the handle, the slideable toothpick tool comprising a base portion and a pointed tip.

9. The dental cleaning tool in accordance with claim 8, wherein the slideable brush tool and the slideable toothpick tool are disposed on opposing sides of the handle.

10. The dental cleaning tool in accordance with claim 7, wherein the at least one slideable dental tool slides in a plane substantially parallel to the longitudinal axis from the first position along the side of the handle to the second position.

11. The dental cleaning tool in accordance with claim 7, wherein:
the at least one slideable dental tool further comprises at least one rib; and
the handle further comprises at least one channel sized to receive the at least one rib, the at least one channel sized such that the first end and the second end of the at least one channel correspond to the first, stow position and the second, use position of the at least one slideable dental tool.

12. The dental cleaning tool in accordance with claim 11, wherein the handle further comprises at least one pair of grooves disposed on at least one side of the handle, the at least one pair of grooves configured to engage and retain the at least one slideable dental tool.

13. The dental cleaning tool in accordance with claim 7, wherein the floss holder, handle, and toothpick are formed as a single piece.

14. A dental cleaning tool comprising:
a handle defining a longitudinal axis of the tool, the handle comprising:
a floss holder having a base and two arms extending from the base in perpendicular relation to the longitudinal axis;
at least one strand of floss extending between the two arms;
a toothpick formed as one piece with the handle and having a pointed tip, the toothpick being spaced from the floss holder such that the handle is disposed between the toothpick and the floss holder; and
at least one detachable dental tool formed separately from and detachably mounted to the handle, wherein the at least one detachable dental tool has a mounted, stow position and an unmounted, use position.

15. The dental cleaning tool in accordance with claim 14, wherein the at least one detachable dental tool comprises:
a detachable brush tool mounted to the handle, the detachable brush tool comprising a base portion and a rod portion, bristles being disposed on the rod; and
a detachable toothpick tool mounted to the handle, the detachable toothpick tool comprising a base portion and a pointed tip.

16. The dental cleaning tool in accordance with claim 15, wherein the detachable brush tool and the detachable toothpick tool are disposed on opposing sides of the handle.

17. The dental cleaning tool in accordance with claim 14, wherein the at least one detachable dental tool is mounted to the handle in a plane substantially parallel to the longitudinal axis.

18. The dental cleaning tool in accordance with claim 14, wherein the at least one detachable dental tool is mounted to the handle with retention members integral to the dental cleaning tool.

19. The dental cleaning tool in accordance with claim 14, wherein the at least one detachable dental tool comprises retention posts integral to the at least one detachable dental tool sized and shaped to interface with retention points integral to the handle.

20. The dental cleaning tool in accordance with claim 14, wherein the floss holder, handle, and toothpick are formed as a single piece.
